(19) United States
(12) Patent Application Publication
(10) Pub. No.: US 2014/0184100 A1
(43) Pub. Date: Jul. 3, 2014

(54) Illumination Control Device and Illumination Control System

(71) Applicants: Kabushiki Kaisha Toshiba, Tokyo (JP); Toshiba Lighting & Technology Corporation, Yokosuka-shi (JP)

(72) Inventors: Hisashi Yamada, Kawasaki-shi (JP); Yoshiki Terashima, Kawasaki-shi (JP); Hisashi Hayashi, Yokohama-shi (JP)

(73) Assignees: KABUSHIKI KAISHA TOSHIBA, Tokyo (JP); TOSHIBA LIGHTING & TECHNOLOGY CORPORATION, Yokosuka-shi (JP)

(21) Appl. No.: 14/024,657

(22) Filed: Sep. 12, 2013

(30) Foreign Application Priority Data
Dec. 27, 2012 (JP) 2012-286295

(51) Int. Cl. H05B 37/02

(52) U.S. Cl. CPC H05B 37/02
USPC 315/297

(57) ABSTRACT

An illumination control system includes an illumination control device, and a plurality of illumination lamps that are connected to the illumination control device via a network and are controlled by a control signal from the illumination control device. In addition, the illumination control device includes a reception unit configured to receive route information specified by a user from a user terminal, a decision unit configured to decide a schedule in which an illumination lamp which is a control target and an illumination process executed in the illumination lamp are specified according to the route information, and a transmission unit configured to transmit a control signal according to the schedule to the illumination lamp which is a control target.

### CROSS-REFERENCE TO RELATED APPLICATION

This application is based upon and claims the benefit of priority from Japanese Patent Application No. 2012-286295, filed Dec. 27, 2012, the entire contents of which are incorporated herein by reference.

### FIELD

Embodiments described herein relate generally to an illumination control device and an illumination control system.

### BACKGROUND

In the related art, a system is proposed which manages and controls a plurality of illumination devices in an integrated fashion. For example, a system is proposed in which illumination devices in ordinary houses are connected to a management device via a network, and the management device can control turning-on, turning-off, and dimming of each illumination device. In addition, for example, a system is proposed in which street lights are connected via a network, and a manager can communicate with a management device of any street light via the network. Further, a system is also proposed in which failures or the like of illumination devices are detected through wireless communication.

However, in the system in the related art in which a plurality of illumination devices are connected to a control device via a network so as to perform control of turning-on, turning-off, and the like thereof, a technique in which a light quantity or the like of a street light is controlled according to the needs of a user is not proposed.

For example, if a user returns home at midnight, it is typically expected that the user selects not a route where street lights fail or a dark route where street lights are not originally installed but a route where street lights are turned on brightly. Therefore, there is much traffic in the brightly illuminated route which has a high probability of being selected as a return route by the user, whereas there is little traffic in the dimly illuminated route which has a low probability of being selected as a return route by the user.

Therefore, it may be considered that all routes which may possibly be used by the user are illuminated brightly such that various routes can be used by the user. However, if street lights are installed having the same density in all streets through which the user may possibly pass, and all the street lights emit light at a high light quantity in the nighttime, this is not preferable from the viewpoint of saving energy consumption since the street lights are continuously turned on at a high light quantity even if there is practically no passenger.

### DESCRIPTION OF THE DRAWINGS

FIG. 1 is a diagram illustrating an outline of an example of an illumination control system according to a first embodiment.

FIG. 2 is a diagram illustrating an outline of an example of information stored in a user information storage portion according to the first embodiment.

FIG. 3 is a diagram illustrating an outline of an example of information stored in a street light information storage portion according to the first embodiment.

FIG. 4 is a diagram illustrating an outline of an example of information stored in a control content storage portion according to the first embodiment.

FIG. 5 is a diagram illustrating an example of a screen displayed in a user terminal when information is transmitted to a management device according to the first embodiment.

FIG. 6 is a flowchart illustrating an example of a flow of an illumination control process in the illumination control system according to the first embodiment.

FIG. 7A is a diagram illustrating an example of a display screen of the user terminal related to a modification example of the first embodiment.

FIG. 7B is a diagram illustrating another example of a display screen of the user terminal related to a modification example of the first embodiment.

FIG. 8 is a diagram illustrating an example of an illumination control system according to a second embodiment.

FIG. 9 is a diagram illustrating an outline of an example of information stored in a control content storage portion according to the second embodiment.

FIG. 10 is a diagram illustrating an outline of an example of information stored in a charging information storage portion according to the second embodiment.

FIG. 11 is a diagram illustrating an example of a display screen displayed in a user terminal in the illumination control system according to the second embodiment.

FIG. 12 is a flowchart illustrating an example of a flow of a discounted rate calculation process in the illumination control system according to the second embodiment.

FIG. 13 is a flowchart illustrating an example of a flow of a recommended route presenting process in the illumination control system according to the second embodiment.

FIG. 14A is a diagram illustrating an illumination effect of a street due to leakage light.

FIG. 14B is a diagram illustrating an arrangement of buildings and illuminance measurement points as an example for describing influence of leakage light.

FIG. 14C is a table illustrating data of the buildings exemplified in FIG. 14B.

FIG. 14D is a graph illustrating a measurement result using photographic photometry of illuminance at the illuminance measurement points shown in FIG. 14B.

FIG. 15 is a diagram illustrating an example of a configuration of an illumination control system according to a third embodiment.

FIG. 16 is a diagram illustrating an example of information stored in a management target storage portion according to the third embodiment.

FIG. 17 is a diagram illustrating an example of information stored in a spot storage portion according to the third embodiment.

FIG. 18 is a flowchart illustrating an example of a flow of a light quantity deciding process according to the third embodiment.

FIG. 19 is a diagram illustrating an example of a configuration of an illumination control system related to Modification Example 1.

FIG. 20 is a diagram illustrating an example of information stored in a request storage portion related to Modification Example 1.

FIG. 21 is a schematic diagram of an illumination control system related to Modification Example 2.

FIG. 22 is a diagram illustrating an example of information stored in an accumulation information storage portion related to Modification Example 2.

FIG. 23 is a diagram illustrating an example of a configuration of an illumination control system related to Modification Example 4.

### DETAILED DESCRIPTION

An illumination control device according to an exemplary embodiment includes a reception unit configured to receive route information specified by a user from a user terminal; a decision unit configured to decide a schedule in which an illumination lamp which is a control target and an illumination process executed in the illumination lamp are specified according to the route information; and a transmission unit configured to transmit a control signal according to the schedule to the illumination lamp which is a control target.

In addition, the reception unit included in the device according to the exemplary embodiment may be further configured to receive position information and time information correlated with the route information, and the decision unit may be further configured to specify an execution time when the illumination process is executed in the schedule on the basis of the position information and the time information.

Further, the decision unit included in the device according to the exemplary embodiment may be further configured to decide at least one of timing of turning-on and turning-off, illuminance, and color tones of the illumination lamp which is a control target.

In addition, the device according to the exemplary embodiment may further include an integration unit configured to integrate a plurality of schedules decided by the decision unit according to route information specified by a plurality of users into a single schedule on the basis of a route specified by the route information and an execution time of an illumination process specified by the plurality of schedules.

In addition, the device according to the exemplary embodiment may further include a calculation unit configured to calculate a discounted rate applied to users of schedules when the integration unit integrates the plurality of schedules into a single schedule.

An illumination control system according to an exemplary embodiment includes the illumination control device according to the exemplary embodiment; and a plurality of illumination lamps that are connected to the illumination control device via a network and are controlled by a control signal from the illumination control device.

The device according to the exemplary embodiment may further include a calculation unit configured to calculate a light quantity ratio of a plurality of illumination devices illuminating a predetermined spot for achieving predetermined illuminance at the predetermined spot; and a second transmission unit configured to transmit a control signal for instructing illumination control according to the ratio calculated by the calculation unit to the plurality of illumination devices.

The calculation unit included in the device according to the exemplary embodiment may be configured to calculate the light quantity ratio on the basis of a light quantity at which the plurality of illumination devices directly illuminate the predetermined spot and a light quantity at which the plurality of illumination devices indirectly illuminate the predetermined spot.

The calculation unit included in the device according to the exemplary embodiment may be configured to calculate a light quantity ratio at which a sum of power consumption by the plurality of illumination devices is the smallest.

The calculation unit included in the device according to the exemplary embodiment may be configured to calculate the light quantity ratio so as to preferentially use an illumination device having an accumulation function among the plurality of illumination devices.

The device according to the exemplary embodiment may further include a second reception unit configured to receive settings of light quantities of the plurality of illumination devices, and the calculation unit may be configured to calculate a ratio of a light quantity which is equal to or more than the light quantities received by the second reception unit.

The calculation unit included in the device according to the exemplary embodiment may be further configured to calculate a light quantity ratio at which a sum of rates charged for power consumption of the plurality of illumination devices is the smallest.

In the device according to the exemplary embodiment, the plurality of illumination devices may include illumination lamps, and it may be determined whether or not, during turning-on of the illumination lamps, illuminance by the illumination lamps can be achieved by any one of the plurality of illumination devices, and, when it is determined that the illuminance can be achieved, the illumination lamps may be turned off, and the illumination device may be turned on at a rate lower than a rate charged for turning-on of the illumination lamp.

An illumination control system according to an exemplary embodiment includes the illumination control device according to the exemplary embodiment, a plurality of illumination lamps; and a management apparatus configured to manage the plurality of illumination devices.

The management apparatus included in the system according to the exemplary embodiment may be a home energy management system (HEMS) control apparatus or a building and energy management system (BEMS) control apparatus.

Hereinafter, an illumination control device and an illumination control system according to exemplary embodiments will be described in detail with reference to the drawings. In the exemplary embodiments, a constituent element having the same function is given the same reference numeral, and repeated description will be omitted.

### First Embodiment

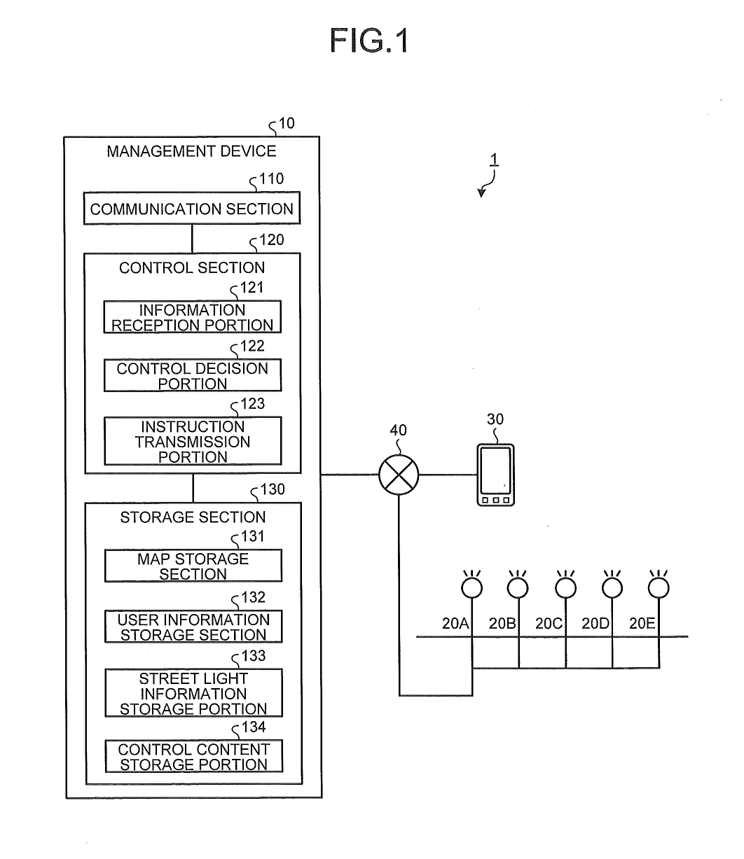

FIG. 1 is a diagram illustrating an outline of an example of an illumination control system according to a first embodiment. With reference to FIG. 1, a description will be made of an example of an illumination control system according to the first embodiment. In the embodiment, the description will be made using a street light as an example of an illumination lamp. A form of the illumination lamp is not particularly limited, and may be a device which illuminates a predetermined district.

Example of Configuration of Illumination Control System 1

The illumination control system 1 according to the first embodiment shown in FIG. 1 includes a management device 10, a plurality of street lights 20A to 20E, and a user terminal 30. The management device 10 is operated as an illumination control device which controls the street lights 20A to 20E. The management device 10 is connected to the street lights 20A to 20E via a network 40, and transmits and receives information to and from the street lights 20A to 20E. The management device 10 communicates with the street lights 20A to 20E via the network 40 so as to control operations of turning-on, turning-off, blinking, and dimming of a plurality of street lights 20A to 20E.

In addition, the management device 10 is connected to the user terminal 30 via the network 40 and transmits and receives information to and from the user terminal 30. For example, the management device 10 receives information which is input to the user terminal 30 by a user, and transmits a control signal to the street lights 20A to 20E according to the information so as to control operations of the streetlights 20A to 20E.

The management device 10 is a management server or the like which controls operations of a plurality of street lights disposed in a predetermined region so as to manage and adjust power consumption by the street lights in an integrated fashion. Further, the management device 10 may be a management server or the like provided in a smart city which manages power consumption in a region or a city in an integrated fashion. In addition, the management device 10 may be a device which manages not only street lights but also any devices which are provided in a public space and is supplied with power for operation.

The street lights 20A to 20E are illumination devices which are provided at any interval along a public space, for example, a normal street on which walkers walk, and illuminate the street. Although five street lights 20A to 20E are shown in FIG. 1, the number of the street lights is not limited to five, and any number of street lights is provided along the street.

In the present embodiment, a description will be made assuming that the street lights 20A to 20E directly receive a control signal from the management device 10 via the network 40 and are operated in response to the control signal. However, the present embodiment is not limited thereto, and a control unit or the like including a control section and a storage section may be provided in each of the street lights 20A to 20E. In this case, the control unit may receive information transmitted from the management device 10 and store the information in the storage section, and the control unit may appropriately read the information from the storage section and control operations of the street lights.

Further, shapes or types of street lights 20A to 20E are not particularly limited, and may use any types such as a fluorescent lamp, a mercury lamp, an LED illumination lamp, and a solar cell type lamp. However, it is assumed that the street lights 20A to 20E are supplied with some kind of energy so as to emit light, and a rate is charged for consumed energy (power or the like).

The user terminal 30 may be any device as long as the device can transmit and receive information to and from the management device 10 through a connection to the network 40, such as, for example, a smart phone, a mobile phone, a personal handyphone system (PHS), a personal digital assistant (PDA), or a tablet personal computer (PC). In addition, the user terminal 30 is not limited to a mobile terminal, and may be a computer installed in a home or an office. In the present embodiment, a description will be made using a mobile phone as an example of the user terminal 30.

The network 40 may be any network such as, for example, the Internet, a local area network (LAN), or a wide area network (WAN). In addition, the network 40 may be, for example, power line communication (PLC). Although FIG. 1 shows that the management device 10, the street lights 20A to 20E, and the user terminal 30 are connected to each other via the network 40, a network connecting the management device 10 to the user terminal 30 and a network connecting the management device 10 to the street lights 20A to 20E may be provided separately from each other. For example, the management device 10 and the street lights 20A to 20E may form a closed network, and the management device 10 and the user terminal 30 may perform communication via a public network.

Example of Configuration of Management Device 10

With reference to FIG. 1, a configuration of the management device 10 will be described more in detail. The management device 10 includes a communication section 110, a control section 120, and a storage section 130. The communication section 110 performs a communication process between the street lights 20A to 20E and the user terminal 30 using the network 40. The control section 120 controls a process in the management device 10 by using information received by the communication section 110, and generates information or the like transmitted to an external device from the communication section 110. The storage section 130 stores information used for a process in the management device 10, information generated in the management device 10, and the like.

The control section 120 includes an information reception portion 121, a control decision portion 122, and an instruction transmission portion 123.

The information reception portion 121 receives user identification information, route information, position information, time information, and the like, transmitted from the user terminal 30. The information reception portion 121 transmits the received information to the control decision portion 122.

For example, the information reception portion 121 receives user identification information for identifying a user who uses the user terminal 30, from the user terminal 30. The user identification information is, for example, a user ID (Identifier) which is given to a registered user who is allowed to access the management device 10, and identifies the user uniquely.

The information reception portion 121 receives route information indicating a return route which is entered on the user terminal 30 by the user. In addition, position information indicating a current position of the user, time information indicating a time point which is designated by the user, and the like, are received.

The control decision portion 122 receives information from the information reception portion 121, and decides control content for the street lights 20A to 20E according to the received information. For example, if route information indicating a return route, position information indicating a current position, and information indicating that the user returns home starting from now are received from the user terminal 30, the control decision portion 122 specifies street lights on the return route of the user on the basis of the route information. Next, the control decision portion 122 calculates the time when the user passes through the route on the basis of the position information and the route information.

In addition, the control decision portion 122 decides control content to be executed in a specified street light. For example, the control decision portion 122 decides timing of turning-on and turning-off, diming, color tones, or the like of the specified street light. The control content may be stored in the management device 10 side in advance in correlation with the user identification information, or may be designated by the user. Further, the management device 10 may correlate a time zone and control content so as to be set and stored in advance.

For example, control content may be set in advance such that control for increasing illuminance of the specified street light to a predetermined level is performed when the user transmits information indicating that the user returns home starting from now and route information after 18 o'clock. In addition, the user may designate control content so as to be transmitted to the management device 10 along with route information. For example, the designation may be performed such that illuminance of street lights on a route designated by the route information is increased to “30 lux” between “19:00 and 19:30”.

The control decision portion 122 decides control content on the basis of preset information or designated information.

The instruction transmission portion 123 generates a control signal on the basis of the control content decided by the control decision portion 122, and transmits the control signal to the street light specified by the control decision portion 122.

Example of Information Stored in Storage Section 130

The storage section 130 includes a map storage portion 131, a user information storage portion 132, a street light information storage portion 133, and a control content storage portion 134.

The map storage portion 131 stores map information. The map storage portion 131 stores at least a map of a region where the street lights 20A to 20E are disposed. In addition, the map storage portion 131 stores at least a map of a district through which a registered user is expected to pass when passing through the region where the street lights 20A to 20E are disposed.

The user information storage portion 132 stores information of a user who is registered in advance and can use an illumination control program of the management device 10.

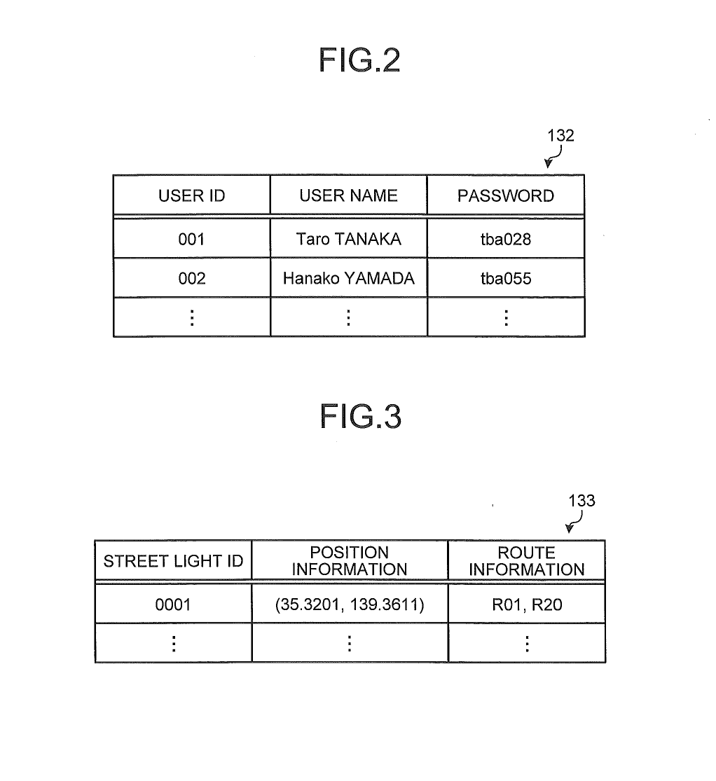

FIG. 2 is a diagram illustrating an outline of an example of information stored in the user information storage portion 132 according to the first embodiment. As shown in FIG. 2, the user information storage portion 132 stores, for example, a user ID, a user name, and a password so as to be correlated with each other. The user ID is an identifier for identifying each user uniquely, and is given to each user when the user is registered. The user name is the name of a user. The password is information which is entered when a user accesses the management device 10 and uses the illumination control program. The password may be set arbitrarily by a user during registration and be stored in the management device 10.

For example, in the example shown in FIG. 2, the user name “Taro TANAKA” and the password “tba028” are stored in correlation with the user ID “001”. In addition, the user name “Hanako YAMADA” and the password “tba055” are stored in correlation with the user ID “002”. Further, information or the like for identifying a user terminal used by a user may be stored in the user information storage portion 132 as user information. Furthermore, information stored in the user information storage portion 132 may be arbitrarily updated by a registered user.

FIG. 3 is a diagram illustrating an outline of an example of information stored in the street light information storage portion 133 according to the first embodiment. As shown in FIG. 3, the street light information storage portion 133 stores a street light ID for uniquely identifying each of street lights managed by the management device 10, position information indicating a place where the corresponding street light disposed, and route information indicating a route along which a user passes through a street where the corresponding street light is disposed.

For example, in the example shown in FIG. 3, the position information “35.3201, 139.3611” and the route information “R01, R20” are stored in correlation with the street light ID “0001”. In this case, a street light identified by the street light ID “0001” is disposed at a spot of “lat. 35°32′1″ and long. 139°36′11″”, and a street where the corresponding street light is disposed is located on a route identified by the identifier “R01” and the identifier “R20”.

In relation to an identifier of a route stored as route information, the management device 10 may give an identifier to a route designated by a user until then so as to be stored, or a manager of the management device 10 may extract routes which are expected to be used by a user and give an identifier to each of the routes so as to be stored.

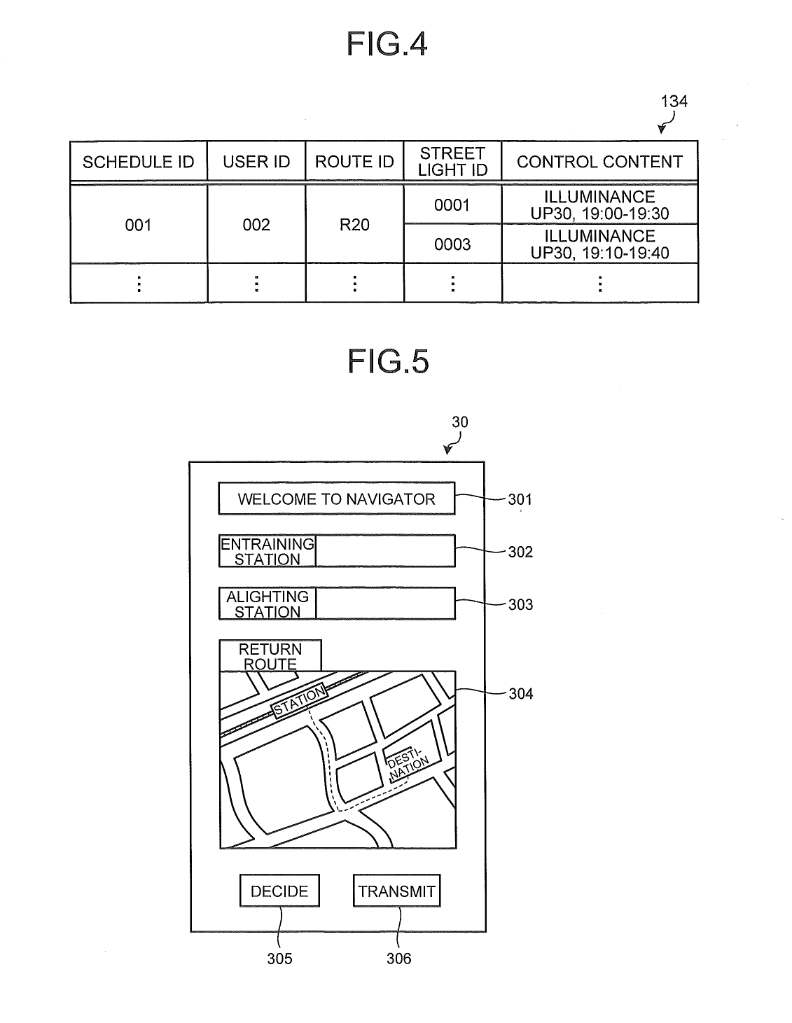

FIG. 4 is a diagram illustrating an outline of an example of information stored in the control content storage portion 134 according to the first embodiment. The control content storage portion 134 stores the control content (hereinafter, also referred to as a “schedule”) which is decided by the control decision portion 122 on the basis of the route information transmitted from the user terminal 30. For example, as shown in FIG. 4, the control content storage portion 134 correlates a schedule ID given corresponding to the route information designated by the user with the user ID for uniquely specifying the user so as to be stored. Further, the control content storage portion 134 correlates a route ID for uniquely specifying a route with an street light ID of a street light which is specified to be located on the route so as to be stored. Furthermore, control content for each street light is stored.

For example, in the example shown in FIG. 4, the user ID “002”, the route ID “R20”, the street light IDs “0001 and 0003”, and the control content “illuminance UP 30, 19:00 to 19:30, and illuminance UP 30, 19:10 to 19:40” are stored in correlation with the schedule ID “001”. This indicates that a user of the user ID “002” transmits information indicating that the user returns home along a route of the route ID “R20” from the user terminal 30, and control of a street light of the street light ID “0001” and a street light of the street light ID “0003” is decided so as to correspond thereto. In addition, this indicates that control is performed on the street light of the street light ID “0001” such that the illuminance thereof increases to 30 lux between 19:00 and 19:30. Further, this indicates that control is performed on the street light of the street light ID “0003” such that the illuminance thereof increases to 30 lux between 19:10 and 19:40.

In addition, information stored in the control content storage portion 134 is deleted each time an execution of a corresponding schedule finishes.

If a user using the illumination control program performs user registration, the management device 10 stores information of the user in the user information storage portion 132 shown in FIG. 2. In addition, if a street light which is a management target is newly installed or is removed, the management device updates the information stored in the street light information storage portion 133 shown in FIG. 3. Further, if a user using the illumination control program transmits route information in order to use the program, the management device decides control content according to the transmitted information so as to be stored in the control content storage portion 134 shown in FIG. 4.

Example of Display Screen of User Terminal

In order to use the illumination control program, a user accesses the network from the user terminal 30 and displays a screen for using the illumination control program. For example, the user accesses a predetermined URL and enters a user ID and a password so as to access the illumination control program. In addition, for example, the illumination control program may be linked to a portal site for management of a home energy management system (HEMS), which is accessed by the user when the HEMS is used outside a user's home.

FIG. 5 is a diagram illustrating an example of a screen displayed in the user terminal 30 when information is transmitted to the management device 10 according to the first embodiment. As shown in FIG. 5, the user terminal 30 displays a field 301 in which the name of the illumination control program “Welcome to navigator” is displayed, and fields 302, 303 and 304 for selecting an “entraining station”, an “alighting station”, and a “return route”. Assuming that a user returns home starting from now, the user displays a screen of “Welcome to navigator” on the user terminal 30, and enters an “entraining station”, an “alighting station”, and a “return route”. The entry may be executed by adjusting a cursor on a map displayed in the screen and selecting a decide button 305 of the screen lower part. A map displayed in the “return route” screen may be displayed centering on a current position of the user, and may display other positions through scrolling. If the overall entry is completed, the user selects a transmit button 306 so as to transmit the information to the management device 10.

If the user transmits the information entered in the “Welcome to navigator” screen, position information indicating a place where the user terminal 30 is located at that time is also transmitted to the management device 10 by a GPS function embedded in the user terminal 30.

The management device 10 calculates the time when the user arrives at the alighting station and starts to walk along the selected return route and the time required to walk along the entire return route from the received information of “entraining station”, “alighting station”, and position information. In addition, in accordance with the calculated time, a control signal for controlling the street lights on the return route is transmitted. Further, if a control section and a storage section are provided in the street lights 20A to 20E, a control signal may be immediately transmitted to the street lights 20A to 20E from the management device 10. Furthermore, the control sections of the street lights 20A to 20E perform control at the time designated by the control signal.

Example of Flow of Illumination Control Process

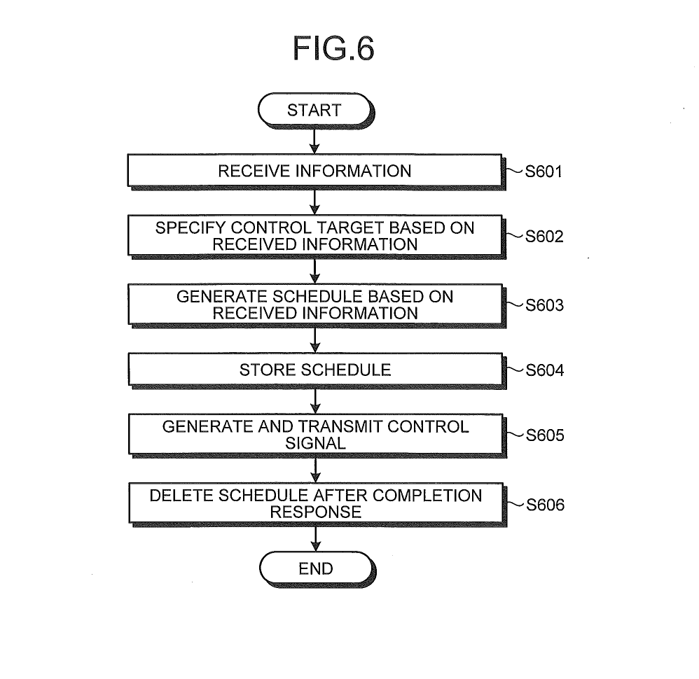

FIG. 6 is a flowchart illustrating an example of a flow of an illumination control process in the illumination control system 1 according to the first embodiment. With reference to FIG. 6, a description will be made of an example of a flow of an illumination control process in the illumination control system 1.

First, the information reception portion 121 of the management device 10 receives route information (an entraining station, an alighting station, a return route, and the like), position information, and the like from the user terminal 30 (Act S601). Next, the control decision portion 122 specifies street lights on the route, which are control targets, based on the received information (Act S602). In addition, the control decision portion 122 decides time for performing control in each street light and control content on the basis of the received information, and generates a schedule in which the control targets, the control time, and the control content are specified (Act S603). If the schedule is specified, the control decision portion 122 stores the decided schedule in the control content storage portion 134 (Act S604). In addition, the instruction transmission portion 123 generates a control signal based on the decided schedule, and transmits the control signal to each street light so as to control illuminance and the like of the street light (Act S605). The control content storage portion 134 deletes the schedule from the control content storage portion 134 if a response of process completion is received from all the street lights specified by the schedule, or the control time specified by the schedule elapses (Act S606).

### Effects of First Embodiment

As above, the illumination control device and the illumination control system according to the first embodiment include a reception unit which receives route information specified by a user from a user terminal, a decision unit which decides a schedule in which an illumination lamp which is a control target and an illumination process performed by the illumination lamp are specified according to the route information, and a transmission unit which transmits a control signal according to the schedule to the illumination lamp which is a control target. For this reason, it is possible to control an illumination lamp on the route on the basis of the route information specified by the user. Therefore, only an illumination lamp on a route desired by the user can be turned on, only a light quantity of the illumination lamp can be increased, and thus the user can pass along the desired route. In addition, since an illumination lamp is turned on or a light quantity thereof is increased only when desired by the user, it is possible to reduce power consumption.

Further, in the illumination control device and the illumination control system according to the first embodiment, the reception unit further receives position information and time information correlated with the route information, and the decision unit specifies an execution time when the illumination process is executed in the schedule on the basis of the position information and time information. For this reason, it is possible to specify time when illumination control of the illumination lamp is executed based on a current position of the user or current time, time for the illumination control, and the like. Therefore, it is possible to execute illumination control of the illumination lamp at the appropriate timing and to thereby reduce power consumption while flexibly accommodating the needs of the user.

Further, in the illumination control device and the illumination control system according to the first embodiment, the decision unit decides at least one of timing of turning-on and turning-off, illuminance, and a color tone of the illumination lamp which is a control target. For this reason, it is possible to execute a variety of illumination control, not only by turning on the illumination lamp, but also by changing colors, increasing illuminance, or combining illuminance with color tones. Therefore, it is possible to flexibly accommodate the needs of the user and to thereby realize illumination suitable for various demands.

### Modification Example of First Embodiment

In addition, in the above description, only information of an entraining station, an alighting station, and a return route is entered in a display screen of the user terminal 30. However, the first embodiment is not limited thereto, and time for performing illumination control may be designated or content of the illumination control may be designated from the user terminal 30.

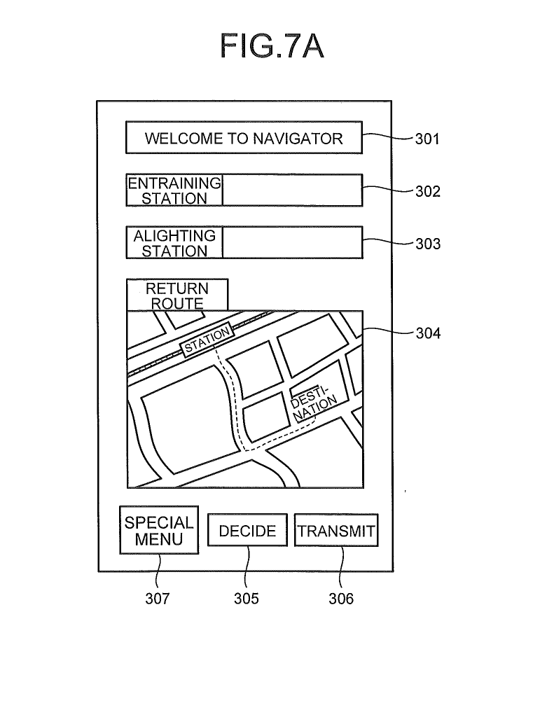

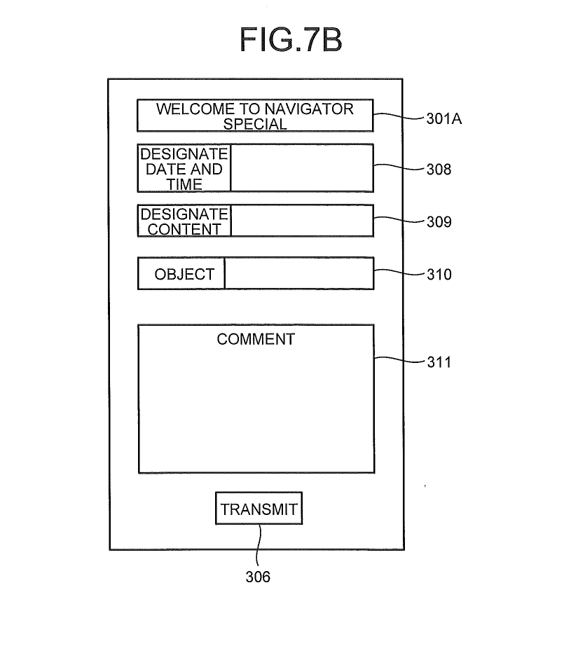

FIGS. 7A and 7B are diagrams illustrating an example of a display screen of the user terminal related to modification examples of the first embodiment. A display screen shown in FIG. 7A is substantially the same as the display screen shown in FIG. 5, but a “special menu” button 307 is further provided at the screen lower part. The user selects this button 307 when the illumination control is requested to be performed in circumstances other than a case where the user returns home starting from now.

If the user selects the button 307, a special menu screen shown in FIG. 7B is displayed. As shown in FIG. 7B, in addition to a field 301A which displays a title “Welcome to navigator special”, a field 308 of “designate date and time”, a field 309 of “designate content”, a field 310 of “object”, and a field 311 of “comment” are displayed on the special menu screen. The user enters the date and time when illumination control is desired to be performed in the field 308. In addition, the user enters the kind of control he/she wants to be performed in the field 309. For example, the user designates an illuminance level, a color tone of illumination, whether or not blinking is performed, an interval of blinking, the number of street lights which are control targets, and the like. In addition, the user enters an object of the illumination control in the field 310. For example, the user enters “birthday”, “Christmas”, “memorial days”, and the like. Further, the user may enter a free comment in the field 311. If the entry is completed, the user selects the transmit button 306. Thus, the entered information is transmitted to the management device 10.

When the information entered on the display screen of FIG. 7B is received, the management device 10 executes illumination control according to the designated date and time and content. In addition, the management device 10 may be configured to determine whether or not the content entered by the user is acceptable by referring to the schedule stored in the control content storage portion 134, and then return an acceptance completion response or a denial response to the user terminal. Further, the management device 10 may set selectable menus as a special menu in advance, and display a selectable menu list instead of the fields 308 to 311 of FIG. 7B. In this case, the user selects a menu from the displayed menu list.

### Effects of Modification Example

As above, in the illumination control device and the illumination control system related to the modification example of the first embodiment, the reception unit further receives position information and time information correlated with route information, and the decision unit specifies an execution time when the illumination process is executed in the schedule based on the position information and the time information. For this reason, it is possible to specify time when illumination control of the illumination lamp is executed based on a current position of the user or current time, time for the illumination control, and the like. Therefore, it is possible to execute illumination control of the illumination lamp at the appropriate timing and to thereby reduce power consumption while flexibly accommodating the needs of the user.

Further, in the illumination control device and the illumination control system related to the modification example of the first embodiment, the decision unit decides at least one of timing of turning-on and turning-off, illuminance, and a color tone of the illumination lamp which is a control target. For this reason, it is possible to execute a variety of illumination control, not only by turning on the illumination lamp, but also by changing colors, increasing illuminance, or combining illuminance with color tones. Therefore, it is possible to flexibly accommodate the needs of the user and to thereby realize illumination suitable for various demands and situations. Further, it is possible to perform flexible control of an illumination lamp according to other usages as well as a case where the user returns home starting from now.

### Second Embodiment

In the above-described first embodiment, an illumination control process is performed when a single user selects a return route and transmits information. Next, as a second embodiment, a description will be made of an example in which the management device receives route information from a plurality of users, and when many users select the same return route, the route is presented to a user as a recommended route.

If a plurality of users return home at the same time zone, and different routes of the same region are selected as return routes, to integrate the return routes and restrict street lights of which illuminance is increased is preferable from the viewpoint of a reduction in power consumption. However, to merely present the integrated return route to a user does not give the user an incentive to select the integrated return route. Therefore, in the second embodiment, a charge for the illumination control program is made, and, if return routes of a plurality of users overlap each other, a discounted rate is presented according to the number of users selecting the same return route, thereby prompting a user to select the integrated route.

Example of Configuration of Illumination Control System According to Second Embodiment

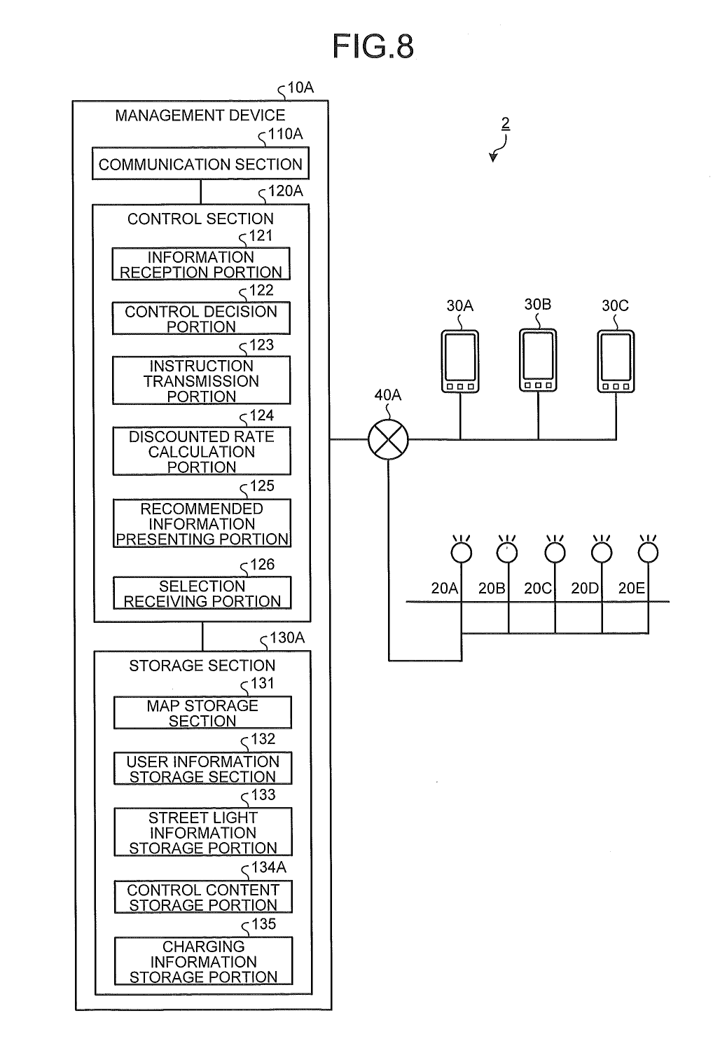

FIG. 8 is a diagram illustrating an example of a configuration of an illumination control system 2 according to a second embodiment. Hereinafter, with reference to FIG. 8, a configuration of the illumination control system 2 according to the second embodiment will be described. In addition, in constituent elements of the illumination control system 2 according to the second embodiment, the same constituent element and function as in the first embodiment are given the same reference numeral in the drawings, and detailed description thereof will be omitted.

As shown in FIG. 8, the illumination control system 2 according to the second embodiment includes a management device 10A, street lights 20A to 20E, and user terminals 30A, 30B and 30C (hereinafter, if the user terminals are not required to be differentiated from each other, the user terminals are separately or collectively referred to as a “user terminal 30”). The management device 10A, the street lights 20A to 20E, and the user terminals 30A, 30B and 30C are connected so as to communicate with each other via a network 40A. The street lights 20A to 20E, the user terminals 30A, 30B and 30C, and the network 40A are the same as the street lights 20A to 20E, the user terminal 30, and the network 40 of the first embodiment. In addition, the number of street lights and user terminals shown in FIG. 8 is only an example, and any number of street lights and user terminals may be connected to the management device 10A via the network.

The management device 10A receives route information from a plurality of user terminals 30A, 30B and 30C, and decides control content of a street light on the basis of the received route information. At this time, if routes and time zones specified by information received from a plurality of users via the user terminals overlap each other, the management device 10A integrates a plurality of schedules for the plurality of users into a single schedule. For example, if control time zones specified by information received from a plurality of users overlap each other, the management device 10A further determines whether or not routes overlap each other. In addition, if the routes overlap each other, schedules for the plurality of users are integrated into a single schedule. Further, the management device 10A determines whether or not a time zone specified by new route information received from a user overlaps time zones of other schedules. Furthermore, if the time zone overlaps other time zones, the management device 10A further determines whether or not two routes are adjacent to each other, and presents the user a discounted rate so as to prompt integration if the two routes are adjacent to each other. If the user makes a response in which the user agrees to the integration, the management device 10A integrates two schedules into a single schedule.

Example of Configuration of Management Device 10A

The management device 10A according to the second embodiment includes a communication section 110A, a control section 120A, and a storage section 130A. An operation and a function of the communication section 110A are the same as in the first embodiment.

The control section 120A includes a discounted rate calculation portion 124, a recommended information presenting portion 125, and a selection receiving portion 126 in addition to the information reception portion 121, the control decision portion 122, and the instruction transmission portion 123. Operations and functions of the information reception portion 121, the control decision portion 122, and the instruction transmission portion 123 are the same as in the first embodiment. The discounted rate calculation portion 124, the recommended information presenting portion 125, and the selection receiving portion 126 are operated and function as an integration unit which integrates a plurality of schedules into one as a whole.

If the control decision portion 122 decides control content, the decided content (schedule) is stored in a control content storage portion 134A. The discounted rate calculation portion 124 detects schedules in which control time zones overlap each other among schedules stored in the control content storage portion 134A for each predetermined time or each time a new schedule is registered, or in response to an instruction from a user. In addition, if schedules are detected in which the control time zones overlap each other, the discounted rate calculation portion 124 determines whether or not routes of the schedules overlap each other. If the routes overlap each other, the discounted rate calculation portion 124 reduces a rate charged to the user who uses the illumination control program depending on an extent of the routes overlapping each other and an extent of the control time zones overlapping each other, and calculates a discounted rate after the rate is reduced. An amount of the discounted rate calculated is stored in the control content storage portion 134A. In addition, not a discounted rate itself but a discount ratio may be stored.

When a new schedule is registered, the recommended information presenting portion 125 detects a schedule in which a discounted rate is registered among schedules having the same control time zone as the new schedule. In addition, the recommended information presenting portion 125 determines whether or not a route of the new schedule and a route of the detected schedule are in a predetermined distance range. Further, if it is determined that the route of the new schedule and the route of the detected schedule are in a predetermined distance range, the recommended information presenting portion 125 transmits the route of the new schedule, the route of the detected schedule, and a discounted rate applied to the schedules, as recommended route information, to the user terminal 30 of the user stored in correlation with the new schedule.

The selection receiving portion 126 receives a response indicating that the recommended route is selected from the user terminal 30 in relation to the recommended route information transmitted by the recommended information presenting portion 125. The selection receiving portion 126 integrates the schedule registered for the user of the user terminal 30 into the schedule of the recommended route. In other words, a user ID of the user is registered in correlation with a schedule ID of the recommended route, and the schedule originally registered for the user is erased.

Example of Information Stored in Storage Section 130A of Management Device 10A

The storage section 130A is the same as the storage section 130 of the first embodiment in terms of including the map storage portion 131, the user information storage portion 132, and the street light information storage portion 133. The storage section 130A is different from the storage section 130 of the first embodiment in that the control content storage portion 134A is provided instead of the control content storage portion 134, and information of a discounted rate is further stored in the control content storage portion 134A. In addition, the storage section 130A is different from the storage section 130 of the first embodiment in that a charging information storage portion 135 is provided which stores charging information in correlation with each user ID.

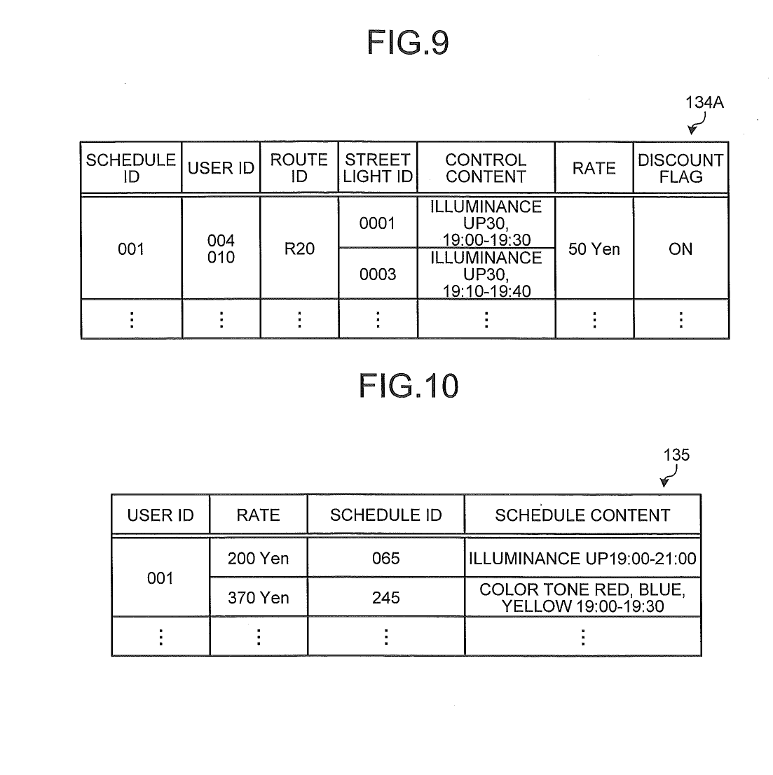

FIG. 9 is a diagram illustrating an outline of an example of information stored in the control content storage portion 134A according to the second embodiment. With reference to FIG. 9, a description will be made of an outline of an example of information stored in the control content storage portion 134A.

As shown in FIG. 9, the control content storage portion 134A stores a schedule ID, a user ID of a user passing along a route of the schedule, a route ID, an street light ID of a street light which is a control target, and control content. This is the same as in the first embodiment. The control content storage portion 134A further stores a rate charged to the user for the illumination control using the schedule. In addition, a discount flag indicating that the rate is a discounted rate is stored.

For example, in the example shown in FIG. 9, the user IDs “004” and “010” are stored as a schedule of the schedule ID “001”, and “50 yen” is stored as a rate. In addition, the discount flag of the schedule of the schedule ID “001” is “ON”. This indicates that, in the schedule of the schedule ID “001”, there are overlapping users in control time zones and control target street lights, and thus a schedule of the user of the user ID “004” and a schedule of the user of the user ID “010” are integrated thereinto. Further, this indicates that the discounted rate is applied as a result of the integration.

FIG. 10 is a diagram illustrating an outline of an example of information stored in the charging information storage portion 135 according to the second embodiment. The charging information storage portion 135 stores an amount of a rate charged to each user and a schedule ID of a schedule to which the rate is applied in correlation with a user ID. For example, the example of FIG. 10 shows that the rate “200 yen” for the schedule of the schedule ID “065” is charged and the rate “370 yen” for the schedule of the schedule ID “245” is charged, to the user of the user ID “001”. In addition, information for specifying content of a schedule may be stored. In the example shown in FIG. 10, “Illuminance UP 19:00 to 21:00” is stored as schedule content of the schedule ID “065”. Further, “Color tones red, blue and yellow 19:00 to 19:30” is stored as schedule content of the schedule ID “245”.

Example of Recommended Information Display Screen on User Terminal

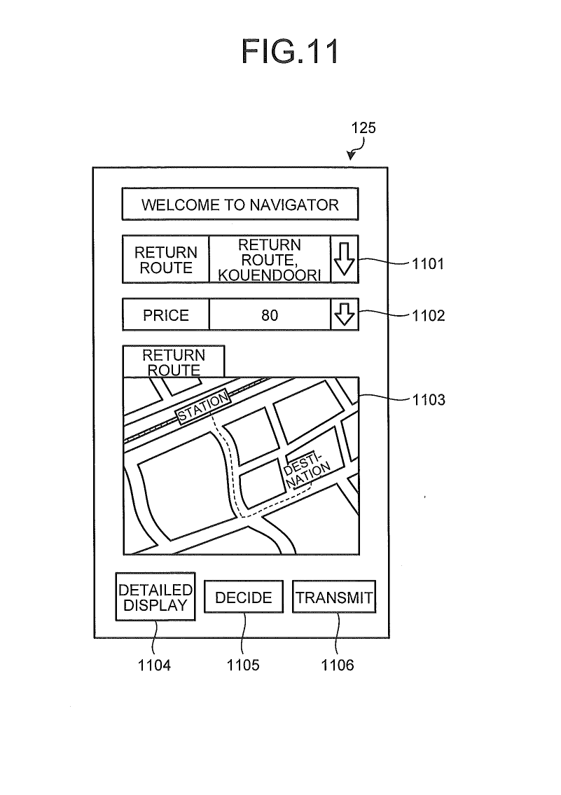

Next, with reference to FIG. 11, a description will be made of an example of a display screen when the recommended route information transmitted from the recommended information presenting portion 125 is displayed on the user terminal 30. FIG. 11 is a diagram illustrating an example of a display screen displayed on the user terminal 30 in the illumination control system 2 according to the second embodiment.

As shown in FIG. 11, if a notification of the recommended route information is sent, a “Welcome to navigator” screen is displayed. On the display screen of FIG. 11, a field 1101 of a “recommended route”, a field 1102 of a “price”, and a field 1103 of a “return route” are displayed. The “recommended route” field 1101 is a field which displays the name or the like for specifying the recommended route information. In the example of FIG. 11, the name “Kouendoori” is displayed. In addition, if there are a plurality of recommended routes, the field 1101 may be set as a drop-down menu, and information of each route may be displayed one by one by selecting the routes from the menu.

The “price” field 1102 displays a rate when the route displayed in the “recommended route” field 1101 is selected. In the example of FIG. 11, “80 (yen)” is displayed. In addition, the “return route” field 1103 is a field which displays the recommended route on the map with highlight or the like.

The user operates the fields 1101, 1102 and 1103 so as to check the recommended route. Further, the user may select a “detailed display” button 1104 of the screen lower part so as to check control content which is scheduled to be executed in the route, the number of users selecting the route, or the like. The user selects a “decide” button 1105 of the screen lower part so as to select a recommended route displayed at that time. In addition, if a “transmit” button 1106 is selected, information of the selected recommended route is transmitted to the management device 10A.

Example of Flow of Discounted Rate Calculation Process According to Second Embodiment

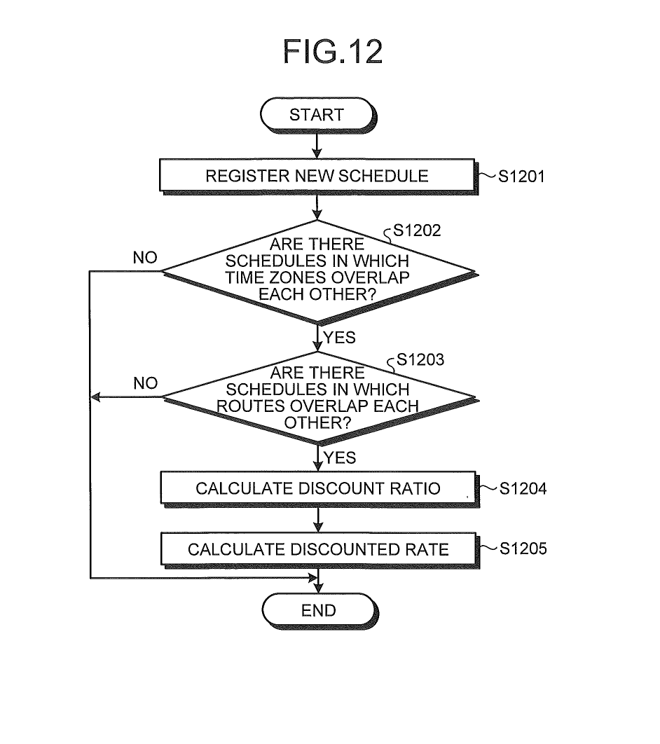

Next, with reference to FIG. 12, a description will be made of a discounted rate calculation process according to the second embodiment. FIG. 12 is a flowchart illustrating an example of a flow of a discounted rate calculation process in the illumination control system 2 according to the second embodiment.

First, the management device 10A performs the same processes as in Act S601 to Act S604 shown in FIG. 6 of the first embodiment so as to store a schedule corresponding to received new route information in the control content storage portion 134A (Act S1201). At this time, a rate at a normal charged rate is stored in the “rate” of the control content storage portion 134A, and the “discount flag” is set to OFF.

Next, the discounted rate calculation portion 124 detects a schedule having the same time zone as the new schedule registered in Act S1201 among schedules stored in the control content storage portion 134A (Act S1202). If a schedule having the same control time zone is not detected (negative in Act S1202), the discounted rate calculation portion 124 finishes the discounted rate calculation process. On the other hand, if a schedule having the same control time zone is detected (affirmative in Act S1202), the discounted rate calculation portion 124 subsequently determines whether or not a route of the detected schedule overlaps a route of the registered new schedule (Act S1203). If it is determined that the routes do not overlap each other (negative in Act S1203), the discounted rate calculation portion 124 finishes the discounted rate calculation process. On the other hand, if it is determined that the routes overlap each other (affirmative in Act S1203), the discounted rate calculation portion 124 calculates a ratio in which the routes overlap each other, and calculates a discount of the rate according to the calculated ratio (Act S1204). In addition, the discounted rate calculation portion 124 calculates a discounted rate so as to be stored in the control content storage portion 134A (Act S1205). At this time, the discounted rate calculation portion 124 sets the corresponding “discount flag” of the control content storage portion 134A to ON. Thus, the discounted rate calculation process finishes.

Example of Flow of Recommended Route Presenting Process According to Second Embodiment

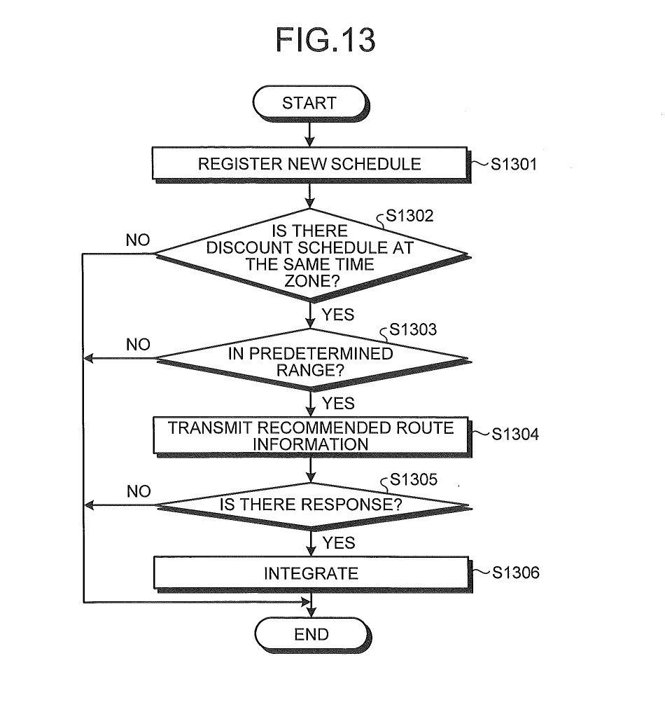

Next, with reference to FIG. 13, a recommended route presenting process according to the second embodiment will be described. FIG. 13 is a flowchart illustrating an example of a flow of a recommended route presenting process in the illumination control system 2 according to the second embodiment.

First, a new schedule is registered (Act S1301), and the recommended information presenting portion 125 detects a schedule in which a control time zone is the same as in the new schedule and thus the discount flag is set to ON, from the control content storage portion 134A (Act S1302). If a corresponding schedule is not detected (negative in Act S1302), the recommended information presenting portion 125 finishes the recommended route presenting process. On the other hand, if a corresponding schedule is detected (affirmative in Act S1302), the recommended information presenting portion 125 determines whether or not a route of the schedule is in a predetermined range from a route of the registered new schedule (Act S1303).

In addition, if it is determined that the route of the schedule is not in a predetermined range (negative in Act S1303), the recommended information presenting portion 125 finishes the recommended route presenting process. On the other hand, if it is determined that the route of the schedule is in a predetermined range (affirmative in Act S1303), the recommended information presenting portion 125 transmits recommended route information including a route specified by the detected schedule and a discounted rate to a user of a user ID stored in correlation with the new schedule (Act S1304). In addition, the recommended information presenting portion 125 determines whether or not a response to the transmitted recommended route information is received (Act S1305).

If it is determined that a response is not received (negative in Act S1305), the recommended information presenting portion 125 finishes the recommended route presenting process. On the other hand, if it is determined that a response is received (affirmative in Act S1305), the recommended information presenting portion 125 integrates the registered new schedule and the detected schedule into one (Act S1306). In other words, the recommended information presenting portion 125 adds the user ID of the user of the registered new schedule to the user ID stored in correlation with the detected schedule. In addition, the recommended information presenting portion 125 erases the registered new schedule. Thus, the recommended route presenting process finishes.

### Effects of Second Embodiment

As above, the illumination control device and the illumination control system according to the second embodiment further include an integration unit which integrates a plurality of schedules decided by the decision unit according to route information specified by a plurality of users into a single schedule on the basis of a route specified by the route information and an execution time of an illumination process specified by the plurality of schedules. For this reason, if routes in which illumination control is desired to be performed by a plurality of users overlap each other, a separate process is not performed but control can be collectively performed. Therefore, it is possible to further suppress power consumption.

In addition, the illumination control device and the illumination control system according to the second embodiment further include a calculation unit which calculates a discounted rate applied to users of schedules when the integration unit integrates the plurality of schedules into a single schedule. For this reason, if routes in which illumination control is desired to be performed by a plurality of users overlap each other, an incentive is given to a user so as to prompt integration. Therefore, it is also possible to improve convenience of a user while suppressing power consumption.

In addition, the illumination control system according to the second embodiment includes the above-described illumination control device, and a plurality of illumination lamps which are connected to the illumination control device via a network and are controlled by a control signal from the illumination control device. For this reason, it is possible to suppress power consumption while flexibly accommodating the needs of a user.

### Third Embodiment

In the first and second embodiments, a plurality of street lights are managed and controlled in an integrated fashion, and thereby it is possible to flexibly accommodate the needs of a user and to reduce power consumption. However, it may be considered that not only street lights but also illumination lamps provided in other facilities are used to illuminate a street.

Illumination Effect of Leakage Light and Reflected Light from Sky

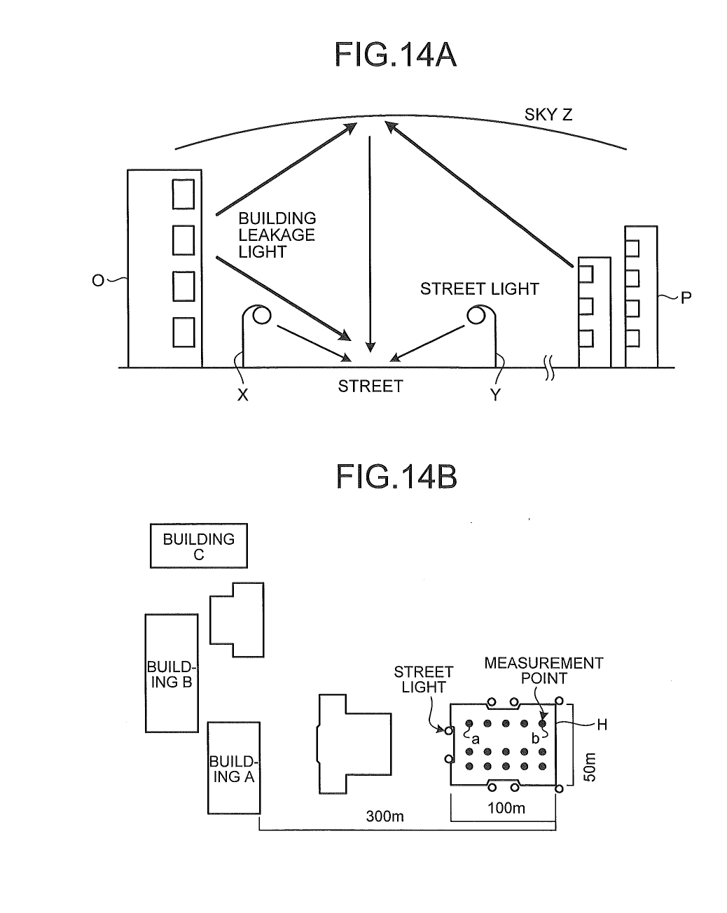

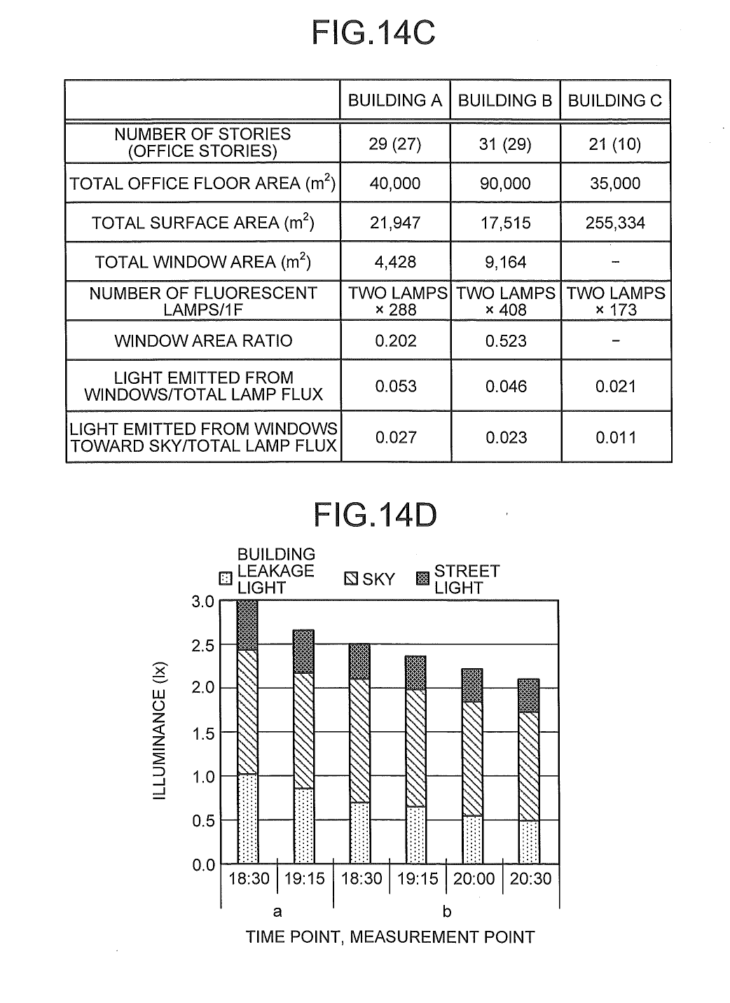

In a city, a street is illuminated to a considerable degree not only by street lights but also with leakage light such as illumination light which leaks out of commercial buildings or ordinary houses. In addition, the leakage light is reflected in the sky, and the earth is illuminated therewith again. A description will be made of influence of leakage light with reference to FIGS. 14A to 14D.

FIG. 14A is a diagram illustrating an illumination effect of a street with leakage light. As shown in FIG. 14A, street lights X and Y are installed on both sides of the street and illuminates the street. In addition, there are buildings O and P around the street lights, and illumination light leaks out of windows thereof. This leakage light is applied to the street, and enhances illumination effects of the street lights. Further, the leakage light from the buildings O and P is radiated toward the sky Z, and is reflected by the sky Z. As a result, the street is directly illuminated with not only the leakage light from the buildings but also with the reflected light from the sky Z.

FIG. 14B is a diagram illustrating an arrangement of buildings and illuminance measurement points as an example for describing influence of leakage light. In the example shown in FIG. 14B, buildings A, B and C are disposed on the left, and a park H is shown at the right location apart therefrom with a specific space. Street lights are disposed around the park H and illuminate the park H. Illumination measurement points are provided at a plurality of spots in the park. Here, illuminance measured at a measurement point a and a measurement point b will be described.

FIG. 14C is a table illustrating data of the buildings exemplified in FIG. 14B. For example, the building A has 29 stories (27 stories) as the number of stories (the number of office stories), a total office floor area of forty thousand square meters, and a total surface area of about twenty thousand square meters. In addition, the total window area is 4428 square meters, and 288 fluorescent lamps each of which has two lamps are installed per floor. An area ratio of the windows is about 0.2, a total lamp flux emitted from the windows is 0.053 lumens, and a total lamp flux emitted from the windows to the sky is 0.027 lumens. Data is also shown in the same manner for the buildings B and C.

FIG. 14D is a graph illustrating a measurement result using photographic photometry of illuminance at the illuminance measurement points shown in FIG. 14B. The left part of the graph of FIG. 14D shows illuminance data at the time point 18:30 and illuminance data at the time point 19:15 at the measurement point a. In addition, the right part of the graph of FIG. 14D shows illuminance data at the time points 18:30, 19:15, 20:00, and 20:30 at the measurement point b.

A practically measured value of the horizontal surface illuminance at the time point 18:30 at the measurement point a is about 3.0 lux. In addition, as shown in FIG. 14D, in the measurement result using the photographic photometry, about 3.0 lux includes about 1.0 lux for building leakage light, about 1.4 lux for light from the sky, and about 0.6 lux for light from the street lights. Also at the time point 19:15, a ratio of building leakage light and light from the sky considerably exceeds a ratio of light from the street lights. The same measurement result is obtained for the measurement point b.

As above, leakage light from the buildings or light from the sky practically has great influence on illumination of the street. Therefore, if illuminance of the street lights can be controlled in consideration of leakage light from the buildings or light from the sky, it is possible to increase an effect of reducing energy consumption and also to provide more effective illumination.

Meanwhile, in the related art, in relation to home appliances disposed indoors, management using a building and energy management system (BEMS), a home energy management system (HEMS), or the like, is proposed. The BEMS manages operational control of equipment, facilities, or the like of a building in an integrated fashion so as to reduce energy consumption. In addition, the HEMS connects home appliances in a house to a network and manages power consumption or the like in an integrated fashion so as to reduce energy consumption.

In addition, a smart city plan is proposed as an idea for reducing energy consumption, targeting the whole region or the whole city without being limited to a house or a building. The smart city indicates, for example, a city or a region in which social infrastructures are optimized and are advanced using a high technology.

A description will be made of an illumination control system which incorporates the HEMS and the BEMS thereinto in consideration of this technology as a third embodiment.

Example of Configuration of Illumination Control System According to Third Embodiment

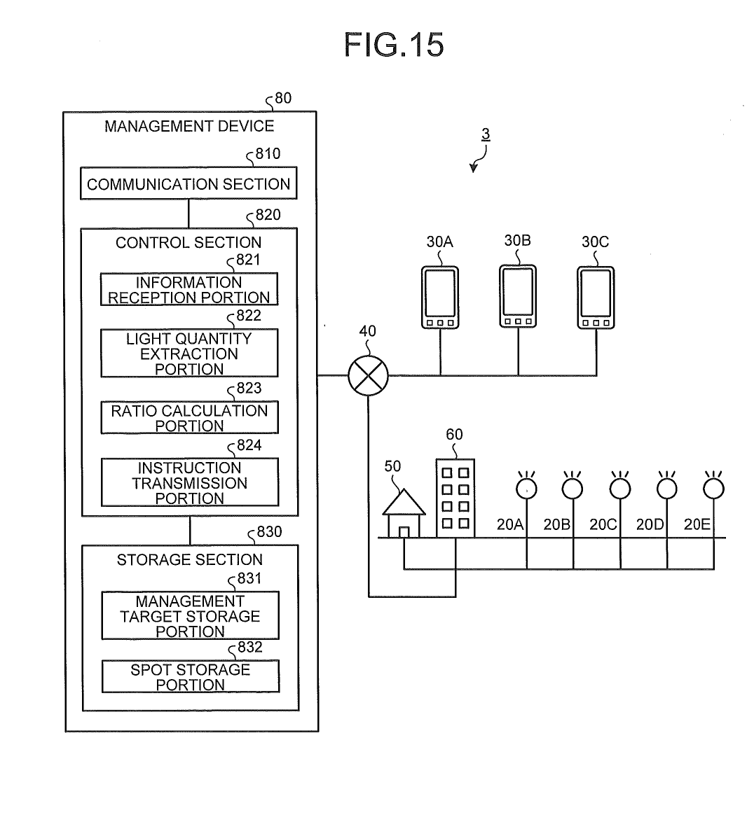

FIG. 15 is a diagram illustrating an example of a configuration of an illumination control system 3 according to a third embodiment. With reference to FIG. 15, an example of a configuration of the illumination control system 3 will be described.

The illumination control system 3 includes a management device 80, street lights 20A to 20E, a HEMS control apparatus 50, and a BEMS control apparatus 60. The management device 80 is connected to each of the street lights 20A to 20E, the HEMS control apparatus 50, and the BEMS control apparatus 60 so as to communicate therewith via a network 40. In addition, the management device 80 is connected to user terminals 30A, 303 and 30C (hereinafter, if the user terminals are not required to be differentiated from each other, the user terminals are separately or collectively referred to as a “user terminal 30”) via the network 40 so as to communicate with each other.

The management device 80 receives, from each of the street lights 20A to 20E, the HEMS control apparatus 50, and the BEMS control apparatus 60, information regarding respective illumination devices included therein. In addition, the management device 80 calculates a light quantity and power consumption of each illumination device. Further, the management device 80 calculates a ratio of light quantities of each illumination device which enables a desired light quantity at a predetermined spot to be obtained and power consumption to be the smallest, based on the calculated light quantity of each illumination device, in consideration of influence of leakage light. Furthermore, the management device 80 controls a light quantity of the illumination device included in each of the street lights 20A to 20E, the HEMS control apparatus 50, and the BEMS control apparatus 60, based on the calculated ratio.

The street lights 20A to 20E are illumination devices which are provided at any interval along a public space, for example, a normal street on which walkers walk and illuminate the street. Although five street lights 20A to 20E are shown in FIG. 15, the number of the street lights is not limited to five, and any number of street lights is provided along the street.

In the present embodiment, a description will be made assuming that the street lights 20A to 20E directly receive a control signal from the management device 80 via the network 40 and are operated in response to the control signal. However, the present embodiment is not limited thereto, a control unit or the like including a control section and a storage section may be provided in each of the street lights 20A to 20E. In this case, the control unit may receive information transmitted from the management device 80 and store the information in the storage section, and the control unit may appropriately read the information from the storage section and control operations of the street lights.

Further, shapes or types of street lights 20A to 20E are not particularly limited, and may use any types such as a fluorescent light, a mercury lamp, an LED illumination lamp, and a solar cell type lamp. However, it is assumed that the street lights 20A to 20E are supplied with some kind of energy so as to emit light, and a rate is charged for consumed energy (power or the like).

The user terminals 30A, 30B and 30C may be any device as long as the device can transmit and receive information to and from the management device 80 through connection to the network 40, such as, for example, a smart phone, a mobile phone, a personal handyphone system (PHS), a personal digital assistant (PDA), or a tablet personal computer (PC). In addition, the user terminal 30 is not limited to a mobile phone, and may use a computer installed in a home or an office. In the present embodiment, a description will be made using a mobile phone as an example of the user terminal 30.

The network 40 may be any network such as, for example, the Internet, a local area network (LAN), or a wide area network (WAN). In addition, the network may be, for example, power line communication (PLC). FIG. 15 shows that the management device 80, the street lights 20A to 20E, the user terminal 30, the HEMS control apparatus 50, and the BEMS control apparatus 60 are connected to each other via the network 40. However, the third embodiment is not limited thereto, and a network connecting the management device 80 to the user terminal 30 and a network connecting the management device 80 to the street lights 20A to 20E, the HEMS control apparatus 50, and the BEMS control apparatus 60 may be provided separately from each other. For example, the management device 80, the street lights 20A to 20E, the HEMS control apparatus 50, and the BEMS control apparatus 60 may form a closed network, and the management device 80 and the user terminal 30 may perform communication via a public network.

The HEMS control apparatus 50 is provided in an ordinary house, and controls and manages home appliances installed in the house. For example, the HEMS control apparatus 50 is connected to illumination devices, an air conditioner, a hot-water heater, an intercom, a battery, and the like, and monitors an operation state or an amount of power consumption of each device. In addition, the HEMS control apparatus 50 controls each of the home appliances in response to an instruction from the user terminal 30.

Further, a description will be made here of an example in which the HEMS control apparatus 50 and the management device 80 are provided separately from each other, the functions of the HEMS control apparatus 50 may be incorporated into the management device 80, and information may be directly transmitted from the home appliances in the house to the management device 80.

The BEMS control apparatus 60 is provided in a building such as a commercial building, and controls and manages of electrical products installed in the building. For example, the BEMS control apparatus 60 is connected to servers, computers, illumination devices, air conditioners, batteries, and the like, and monitors an operation state or an amount of power consumption of each device.

In addition, in the same manner as the HEMS control apparatus 50, the BEMS control apparatus 60 may not be provided separately from the management device 80, but the functions of the BEMS control apparatus 60 may be incorporated into the management device 80. In this case, information such as an operation state or an amount of power consumption is directly transmitted from the electrical products in the building to the management device 80.

Example of Configuration of Management Device 80

With reference to FIG. 15, a configuration of the management device 80 will be described more in detail. The management device 80 includes a communication section 810, a control section 820, and a storage section 830. The communication section 810 performs a communication process with the street lights 20A to 20E, the user terminal 30, the HEMS control apparatus 50, and the BEMS control apparatus 60 via the network 40. The control section 820 controls a process in the management device 80 by using information received by the communication section 810, and generates information or the like transmitted to an external device from the communication section 810. The storage section 830 stores information used for a process in the management device 80, information generated in the management device 80, or the like.

The control section 820 includes an information reception portion 821, a light quantity extraction portion 822, a ratio calculation portion 823, and an instruction transmission portion 824. The information reception portion 821 receives, from the street lights 20A to 20E, the HEMS control apparatus 50, and the BEMS control apparatus 60, information regarding the respective illumination devices included therein. For example, the information reception portion 821 receives information of light quantities of the street lights 20A to 20E and a time zone when the street lights are turned on at the light quantities. In addition, the information reception portion 821 receives information of a light quantity of each of the illumination devices managed by the HEMS control apparatus 50 and a time zone when the illumination device is turned on at the light quantity, from the HEMS control apparatus 50. Further, the information reception portion 821 receives information of a light quantity of each of the illumination devices managed by the BEMS control apparatus 60 and a time zone when the illumination device is turned on at the light quantity, from the BEMS control apparatus 60.

The light quantity extraction portion 822 extracts information of an illumination device which has influence on brightness of a predefined spot on the basis of information received by the information reception portion 821. The management device 80 extracts and stores in advance a spot which is appropriate to adjust illuminance and an illumination device which has influence on illuminance of the spot (refer to a spot storage portion 832 described later and FIG. 17). The light quantity extraction portion 822 extracts information regarding a light quantity or the like of an illumination device which has influence on brightness of a predetermined spot from information received by the information reception portion 821.

The ratio calculation portion 823 adjusts the ratio of a light quantity extracted by the light quantity extraction portion 822 so as to obtain a light quantity necessary for achieving brightness which is requested at the predetermined spot. For example, a case is considered in which the spot is illuminated by an illumination lamp A of a building, a street light B, and an illumination lamp C of a house. In this case, the ratio calculation portion 823 adjusts a light quantity of each of A, B and C such that a total amount becomes a desired light quantity by referring to the light quantity of the illumination lamp A of the building, the light quantity of the street light B, and the light quantity of the house C, extracted by the light quantity extraction portion 822, and calculates an adjusted light quantity. At this time, a ratio of a light quantity may be decided in a range of not exceeding each light quantity extracted by the light quantity extraction portion 822.

The instruction transmission portion 824 transmits each light quantity of A, B and C calculated by the ratio calculation portion 823 to the corresponding street light, the HEMS control apparatus 50, and the BEMS control apparatus 60.

Example of Information Stored in Storage Section 830

The storage section 830 includes a management target storage portion 831, and a spot storage portion 832.

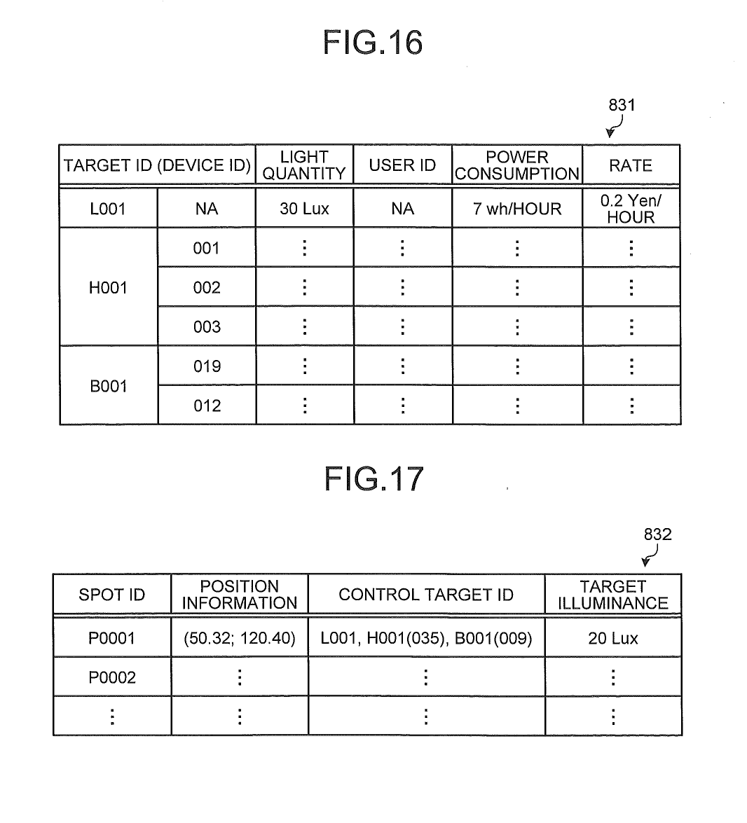

FIG. 16 is a diagram illustrating an example of information stored in the management target storage portion 831 according to the third embodiment. With reference to FIG. 16, an example of information stored in the management target storage portion 831 will be described.

The management target storage portion 831 stores information of the street lights, the BEMS control apparatus 60, and the HEMS control apparatus 50 which are management targets of the management device 80. As shown in FIG. 16, the management target storage portion 831 stores a “target ID” for uniquely identifying the apparatuses which are management targets, and a “device ID” for uniquely identifying a plurality of illumination devices included in the management targets. In addition, the management target storage portion 831 stores a “light quantity” indicating the maximum light quantity of the illumination device in correlation with the “target ID”. Further, if a management target is the HEMS control apparatus 50 or the BEMS control apparatus 60, the management target storage portion 831 stores a “user ID” for uniquely identifying a user of the HEMS control apparatus 50 or the BEMS control apparatus 60. Furthermore, the management target storage portion 831 stores an amount of power consumption of the illumination device as “power consumption”. Moreover, the management target storage portion 831 stores information of a rate applied to the illumination device as “rate”.

For example, in the example shown in FIG. 16, “L001” is stored as the “target ID”, “30 lux” is stored as the “light quantity”, “7 wh/hour” is stored as the “power consumption”, and “0.2 yen/hour” is stored as the “rate”, in correlation with each other. This indicates that a management target is a street light identified by “L001”, a light quantity of the street light is a maximum of 30 lux, power consumption is 7 wh per hour, and a rate is 0.2 yen per hour. In addition, since the street light is managed by the management device 80, the “user ID” is not registered, and, since there is only a single luminaire, the “device ID” is also not registered. For this reason, in the example shown in FIG. 16, “NA” is given.

In addition, in the example shown in FIG. 16, the “device IDs” “001”, “002” and “003” are stored in correlation with “target ID, H001”. This indicates that a management target is a HEMS control apparatus identified by “H001”, and the HEMS control apparatus controls three luminaires identified by “001”, “002”, and “003”.

Next, information stored in the spot storage portion 832 will be described. FIG. 17 is a diagram illustrating an example of information stored in the spot storage portion 832 according to the third embodiment.

The spot storage portion 832 stores information regarding a spot which is used as a reference of illumination control. The spot used as a reference of illumination control is a reference spot at which predetermined illumination is achieved when the management device 80 adjusts a light quantity ratio of a plurality of illumination devices. The management device 80 stores illuminance to be achieved at a plurality of spots in advance, and adjusts a light quantity ratio of a plurality of illumination devices so as to achieve the illuminance.

For example, in the example shown in FIG. 17, “position information”, a “control target ID”, and “target illuminance” are stored in correlation with a “spot ID” for uniquely identifying each spot. The “position information” is information indicating a position of a spot specified by the “spot ID”. The “control target ID” is an identifier for uniquely indicating an illumination device which has influence on brightness of a spot specified by the “spot ID”, and corresponds to the “target ID” and the “device ID” stored in the management target storage portion 831. The “target illuminance” is illuminance which is a target to be achieved at a spot specified by the “spot ID”. The management device 80 adjusts illuminance, that is, a light quantity of an illumination device specified by the “control target ID” so as to achieve this illuminance.

In the example shown in FIG. 17, position information “50.32; 120.40” is stored in correlation with a spot ID “P0001”. This indicates that a place specified by the spot ID “P0001” is a location specified by lat. 50°32′ and long. 120°40′. In addition, in correlation with the spot ID “P0001”, control target IDs “L001, H001 (035), and B001 (009)” are stored, and target illuminance “20 lux” is stored. This indicates that brightness of the spot specified by the spot ID “P0001” is influenced by a street light specified by “L001”. In addition, this indicates that brightness of the spot is influenced by an illumination device of the HEMS control apparatus 50 specified by “H001 (035)” and an illumination device of the BEMS control apparatus 60 specified by “B001 (009)”. Further, this indicates that target illuminance to be achieved at the spot specified by the spot ID “P0001” is 20 lux.

Example of Flow of Light Quantity Decision Process According to Third Embodiment

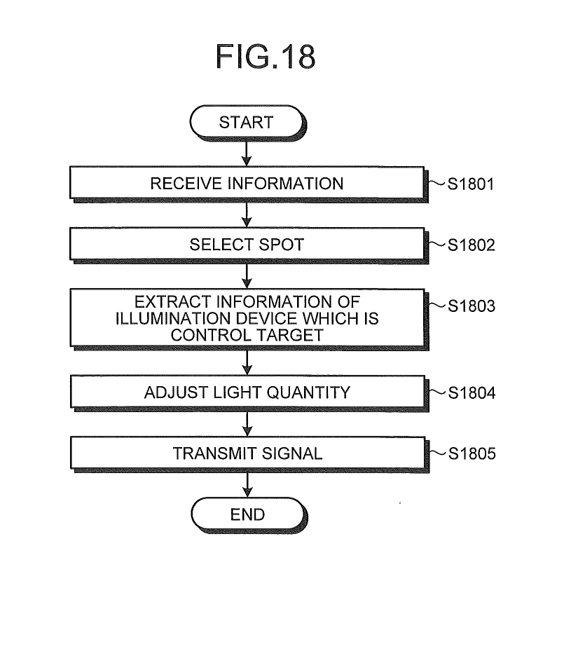

Next, with reference to FIG. 18, a description will be made of a light quantity decision process in the illumination control system 3 according to the third embodiment. FIG. 18 is a flowchart illustrating an example of a flow of a light quantity decision process according to the third embodiment.

First, the information reception portion 821 of the management device 80 receives information for an illumination device from each of the street lights 20A to 20E, the HEMS control apparatus 50, and the BEMS control apparatus 60 (Act S1801). The light quantity extraction portion 822 selects one spot from spots stored in the spot storage portion 832 (Act S1802). In addition, the light quantity extraction portion 822 extracts information of an illumination device which is stored in correlation with a spot ID of the spot and is a control target, from the received information (Act S1803). Further, the ratio calculation portion 823 adjusts a light quantity of each illumination device in order to achieve stored target illuminance (Act S1804). In other words, the ratio calculation portion 823 refers to information of power consumption stored in the management target storage portion 831 and adjusts a light quantity of each illumination device such that a total amount of power consumed by the respective illumination devices becomes the minimum. In addition, at this time, the ratio calculation portion 823 performs the adjustment such that an adjusted light quantity does not exceed the light quantity of each illumination device indicated by the received information.

In addition, the instruction transmission portion 824 transmits a control signal for adjusting a light quantity of each illumination device to a ratio calculated by the ratio calculation portion 823, to the corresponding street light, the HEMS control apparatus 50, and the BEMS control apparatus (Act S1805). Thus, the light quantity decision process finishes.

### Effects of Third Embodiment

As above, the illumination control device and the illumination control system according to the third embodiment further include a calculation unit which calculates a light quantity ratio of a plurality of illumination devices illuminating a predetermined spot for achieving predetermined illuminance at the predetermined spot, and a second transmission unit which transmits a control signal for instructing illumination control according to the ratio calculated by the calculation unit to the plurality of illumination devices. For this reason, it is possible to realize desired illuminance at a predetermined spot by adjusting illumination effects by a plurality of illumination devices. Therefore, it is possible to decide balance between the illumination devices and to thereby further reduce power consumption while taking into consideration states of a plurality of illumination devices, an amount of power consumption, electricity rate, and the like.

In addition, in the illumination control device and the illumination control system according to the third embodiment, the calculation unit calculates a light quantity ratio on the basis of a light quantity at which a plurality of illumination device directly illuminate a predetermined spot and a light quantity at which the plurality of illumination devices indirectly illuminate the predetermined spot. For this reason, it is possible to illuminate a predetermined spot by effectively using not only direct illumination effect from illumination devices but also a variety of light such as leakage light from a building, leakage light from a house, and reflected light from the sky. Therefore, it is possible to further reduce power consumption.

In addition, in the illumination control device and illumination control system according to the third embodiment, the calculation unit calculates a light quantity ratio at which a sum of power consumption by a plurality of illumination devices is the smallest. For this reason, a plurality of illumination devices are managed as a whole, and thus it is possible to reduce the overall power consumption of buildings, houses, public facilities, and the like, for example, in a smart city or the like.

### Modification Example 1 of Third Embodiment

Meanwhile, in the above-described third embodiment, a ratio is decided such that a sum total of an amount of power consumption by the respective illumination devices is the smallest. However, the third embodiment is not limited thereto, and any one of the illumination devices may be made to emit light at a predetermined light quantity irrespective of the sum total of the amount of power consumption. In Modification Example 1, a description will be made of an example of maintaining a light quantity of an illumination device of the HEMS or the BEMS in response to a request from a user.

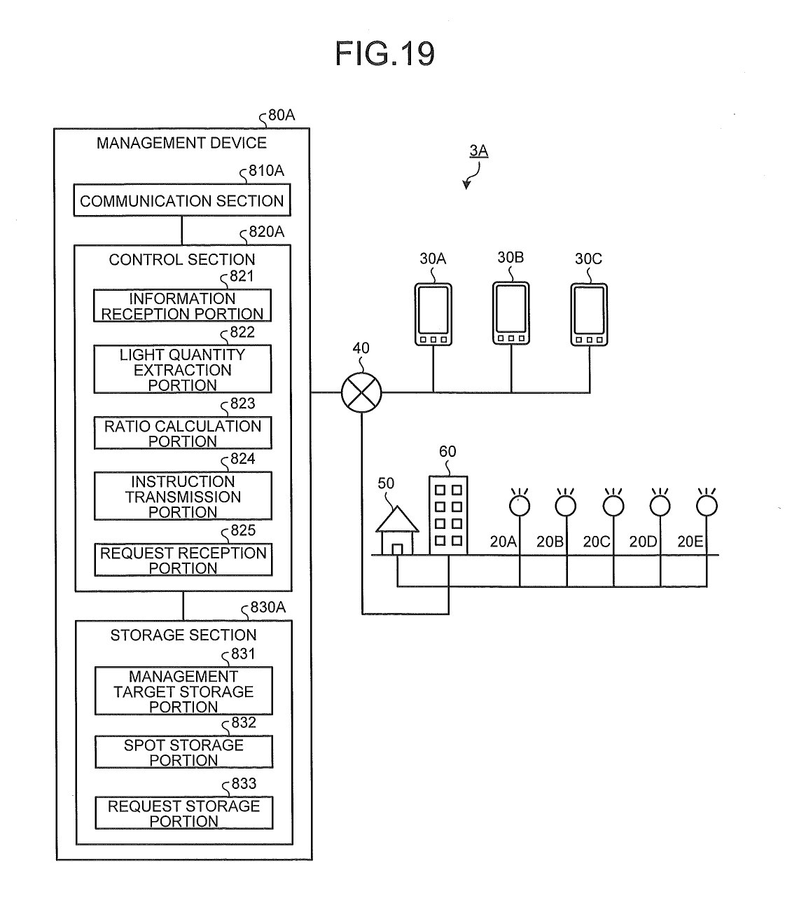

FIG. 19 is a diagram illustrating an example of a configuration of an illumination control system 3A related to Modification Example 1. A configuration of the illumination control system 3A is the same as the configuration of the illumination control system 3 shown in FIG. 15. However, a management device 80A includes a communication section 810A, a control section 820A, and a storage section 830A. In addition, there is a difference from the illumination control system 3 shown in FIG. 15 in that the control section 820A includes a request reception portion 825, and the storage section 830A includes a request storage portion 833. Hereinafter, the request reception portion 825 and the request storage portion 833 will be described.

The request reception portion 825 receives, from the HEMS control apparatus 50 and the BEMS control apparatus 60, requests for light quantities of respective illumination devices included therein. The requests received by the request reception portion 825 are stored in the request storage portion 833.

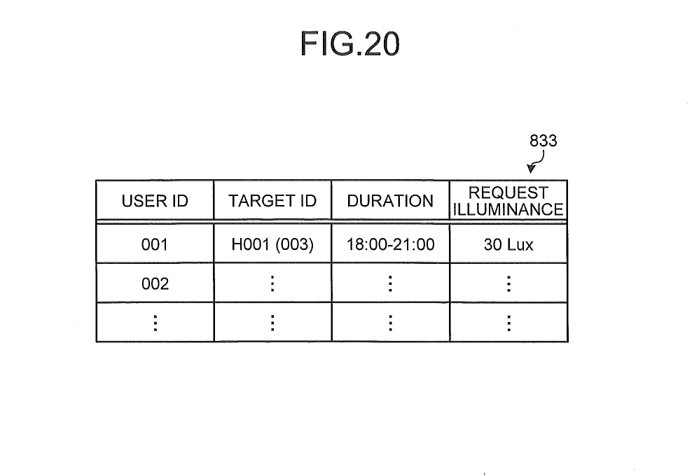

FIG. 20 is a diagram illustrating an example of information stored in the request storage portion 833 related to Modification Example 1. As shown in FIG. 20, the request storage portion 833 stores information regarding the requests received by the request reception portion 825. For example, as shown in FIG. 20, the request storage portion 833 stores a “user ID”, a “target ID”, “duration”, and “request illuminance”. The “user ID” specifies a user who transmits a request. The “target ID” specifies an illumination device which is a control target on the basis of the request from the user. The “duration” specifies time when control is performed by the request. The “request illuminance” indicates illuminance which is requested by the user.

For example, in the example shown in FIG. 20, “001” is stored as the user ID, “H001 (003)” is stored as the target ID, “18:00 to 21:00” is stored as the duration, and “30 lux” is stored as the request illuminance. This indicates a request for an illumination device specified by “003” among devices controlled by the HEMS control apparatus specified by “H001” from a user of the user ID “001”. In addition, this indicates that the request is a request for maintaining illuminance of the illumination device at 30 lux between 18:00 and 21:00.

As above, the illumination control device and the illumination control system related to Modification Example 1 of the third embodiment further include a second reception unit which receives settings of light quantities of a plurality of illumination devices, and the calculation unit calculates a ratio of a light quantity which is equal to or more than the light quantities received by the second reception unit. For this reason, a manager or a user of each illumination device requests the second reception unit to set a light quantity when a predetermined light quantity is desired to be secured, and thereby it is possible to secure a desired light quantity. Therefore, it is possible to suppress power consumption as a whole while responding to an individual request from a user.

### Modification Example 2 of Third Embodiment

In addition, the third embodiment is not limited to above-described example, and, if any one of illumination devices includes a battery, the illumination device with a battery may be preferentially made to emit light at the maximum light quantity. As Modification Example 2, a description will be made of an example of preferentially using an illumination device including a battery.

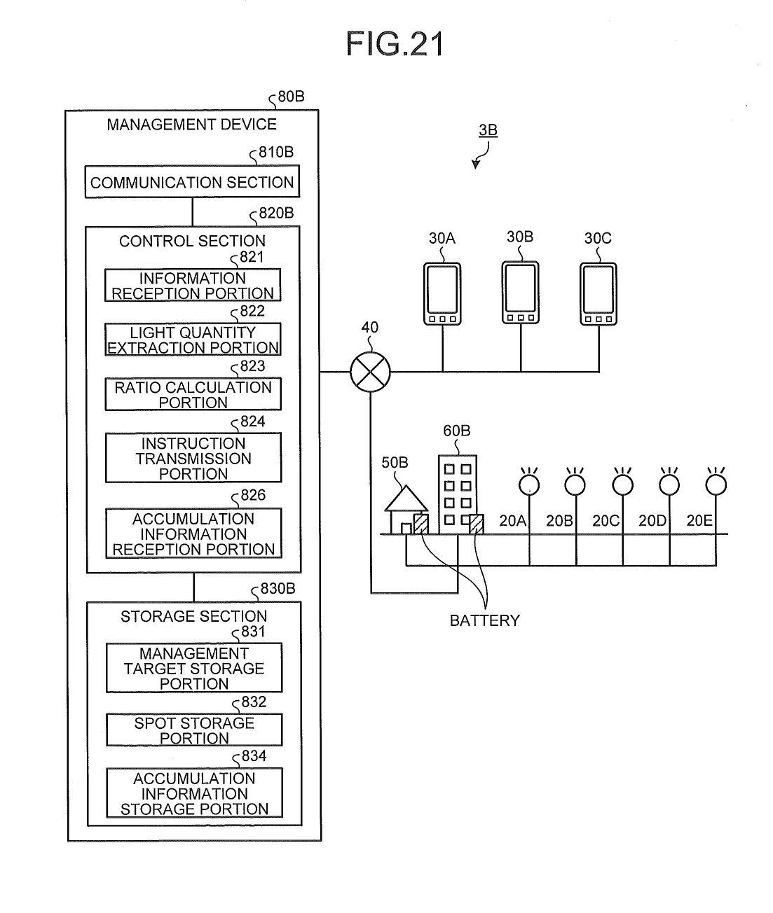

FIG. 21 is a schematic diagram of an illumination control system 3B related to Modification Example 2. As shown in FIG. 21, in Modification Example 2, a battery is provided in a building controlled by a BEMS control apparatus 60B. In addition, a battery is also provided in a house controlled by a HEMS control apparatus 50B. Further, batteries may be provided in the street lights 20A to 20E.

In addition, in the illumination control system 3B of Modification Example 2, a management device 80B includes a communication section 810B, a control section 820B, and a storage section 830B. In addition, the control section 820B includes an accumulation information reception portion 826, and the storage section 830B includes an accumulation information storage portion 834. The other configurations are the same as the configurations of the illumination control system 3 shown in FIG. 15. Therefore, description of the same functional unit will be omitted. Hereinafter, the accumulation information reception portion 826 and the accumulation information storage portion 834 will be described.

The accumulation information reception portion 826 of the management device 80B receives, from the HEMS control apparatus 50B and the BEMS control apparatus 60B, information regarding a residual accumulation amount of a battery included in each of the apparatuses. The accumulation information reception portion 826 stores the received information in the accumulation information storage portion 834.

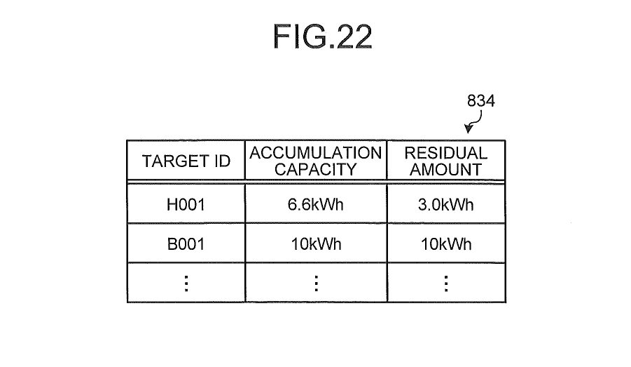

FIG. 22 is a diagram illustrating an example of information stored in the accumulation information storage portion 834 related to Modification Example 2. As shown in FIG. 22, the accumulation information storage portion 834 stores a “target ID” as information for specifying the HEMS control apparatus SOB of a house including a battery or the BEMS control apparatus 60B of a building including a battery. In addition, the accumulation information storage portion 834 stores an “accumulation capacity” indicating a capacity of the installed battery, and a “residual amount” indicating an residual accumulation amount.

For example, the example shown in FIG. 22 indicates that, in a battery controlled by the HEMS control apparatus specified by the target ID “H001”, a capacity of the battery is “6.6 kWh”, and a residual amount is “3.0 kWh”.

When a ratio of a light quantity of each illumination device is decided, the ratio calculation portion 823 refers to the accumulation information storage portion 834, and decides a light quantity ratio such that an illumination device controlled by the HEMS control apparatus or the BEMS control apparatus which includes a battery having a large residual amount is preferentially used.

As above, in the illumination control device and the illumination control system related to Modification Example 2 of the third embodiment, the calculation unit calculates a light quantity ratio so as to preferentially use an illumination device having an accumulation function among a plurality of illumination devices. For this reason, an illumination device which can be supplied with power from a battery can be preferentially used, and thus it is possible to secure sufficient illuminance by preferentially using the illumination device having a margin in the supply of power. In addition, it is possible to suppress power consumption as a whole.

### Modification Example 3 of Third Embodiment

In addition, the third embodiment is not limited to the above-described example, and a light quantity of each illumination device may be adjusted such that a total amount of power rates becomes the minimum when rate systems applied to the respective illumination devices are different, or the like. The management target storage portion 831 of FIG. 16 stores a rate in correlation with each illumination device. Therefore, when a light quantity ratio of each illumination device is decided, the ratio calculation portion 823 refers to the rates stored in the management target storage portion 831 and decides a light quantity ratio of each illumination device such that a total amount of power rates becomes the minimum. In this way, it is possible to suppress a rate charged to the overall illumination control system.

As above, in the illumination control device and the illumination control system according to Modification Example 3 of the third embodiment, the calculation unit calculates a light quantity ratio at which a sum of rates charged for power consumption of a plurality of illumination devices is the smallest. For this reason, even if power rate systems respectively applied to a plurality of illumination devices are different, it is possible to suppress a rate charged for the overall power consumption.

### Modification Example 4 of Third Embodiment

In addition, the third embodiment is not limited to the above-described example, and, if an equivalent light quantity can be obtained from other illumination devices when illumination is performed using street lights, a user (manager) of the illumination devices may be presented a discounted rate and be asked to turn on the illumination devices. As Modification Example 4, a description will be made of a case where a discounted rate is presented to a user, and an illumination device is turned on with the user's consent to turning on the illumination device.

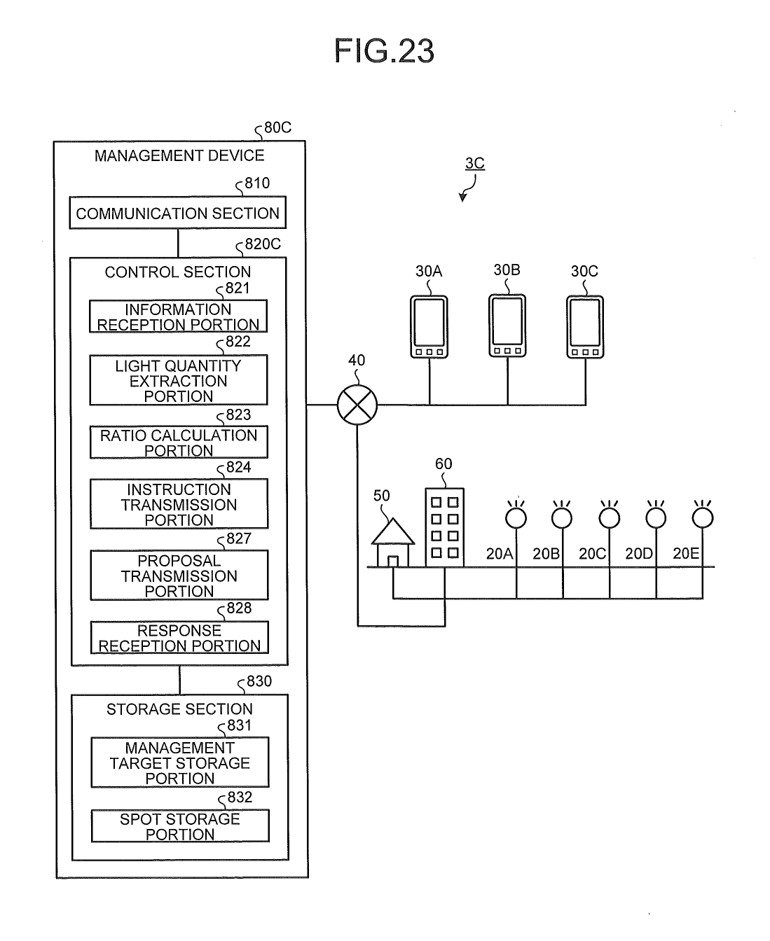

FIG. 23 is a diagram illustrating an example of a configuration of an illumination control system 3C related to Modification Example 4. The illumination control system 3C includes a management device 80C. The management device 80C related to Modification Example 4 includes a control section 820C. The control section 820C has a proposal transmission portion 827 and a response reception portion 828. When street lights illuminate a street, the proposal transmission portion 827 determines whether or not the same illuminance is obtained from other illumination devices, for example, using leakage light from a building or leakage light from a house. In addition, if it is determined that the same illuminance is obtained, a lower rate than a rate charged when the street lights are turned on is presented to a BEMS control apparatus of the building or a HEMS control apparatus of the house so as to sound out whether or not to use an illumination device.

The response reception portion 828 receives a consent response from a user of the sounded BEMS control apparatus or HEMS control apparatus, that is, an owner of the building or a resident of the house. If a consent response is received, the response reception portion 828 starts illumination using an illumination device of the apparatus which returns the consent response, and turns off the street lights.

As above, the illumination control device and the illumination control system related to Modification Example 4 of the third embodiment include illumination lamps as a plurality of illumination devices, determines whether or not, during turning-on of the illumination lamps, illuminance by the illumination lamps can be achieved by any one of the plurality of illumination devices, and, when it is determined that the illuminance can be achieved, turns off the illumination lamps, and turns on the illumination device at a rate lower than a rate charged for turning-on of the illumination lamp. For this reason, if use of an illumination lamp is desired to be avoided, illumination can be performed using other illumination devices, and thus it is possible to effectively use facilities as a whole city.

As described above, in the illumination control device and the illumination control system of the embodiments, it is possible to perform flexible control of an illumination lamp according to the needs of a user and to reduce power consumption.

Thus, the first to third embodiments and the modification examples are described. The illumination control system according to the embodiments and the modification examples includes the above-described illumination control device, a plurality of illumination lamps, and a management apparatus managing a plurality of illumination devices. For this reason, it is possible to flexibly accommodate the needs of a user and to reduce power consumption.

In addition, the illumination control system according to the embodiments and the modification examples includes a HEMS control apparatus or a BEMS control apparatus as the management apparatus. For this reason, illumination devices in a building or an ordinary house can be collectively managed, and flexible illumination control can be realized, thereby reducing power consumption as a whole.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. An illumination control device comprising:
a reception unit configured to receive route information specified by a user from a user terminal;
a decision unit configured to decide a schedule in which an illumination lamp which is a control target and an illumination process executed in the illumination lamp are specified according to the route information; and
a transmission unit configured to transmit a control signal according to the schedule to the illumination lamp which is a control target.

2. The device according to claim 1, wherein the reception unit is further configured to receive position information and time information correlated with the route information, and
wherein the decision unit is further configured to specify an execution time when the illumination process is executed in the schedule on the basis of the position information and the time information.

3. The device according to claim 1, wherein the decision unit is further configured to decide at least one of timing of turning-on and turning-off, illuminance, and color tones of the illumination lamp which is a control target.

4. The device according to claim 1, further comprising:
an integration unit configured to integrate a plurality of schedules decided by the decision unit according to route information specified by a plurality of users into a single schedule on the basis of a route specified by the route information and an execution time of an illumination process specified by the plurality of schedules.

5. The device according to claim 4, further comprising:
a calculation unit configured to calculate a discounted rate applied to users of schedules when the integration unit integrates the plurality of schedules into a single schedule.

6. An illumination control system comprising:
the illumination control device according to claim 1; and
a plurality of illumination lamps that are connected to the illumination control device via a network and are controlled by a control signal from the illumination control device.

7. The device according to claim 1, further comprising:
a calculation unit configured to calculate a light quantity ratio of a plurality of illumination devices illuminating a predetermined spot for achieving predetermined illuminance at the predetermined spot; and
a second transmission unit configured to transmit a control signal for instructing illumination control according to the ratio calculated by the calculation unit to the plurality of illumination devices.

8. The device according to claim 7, wherein the calculation unit is configured to calculate the light quantity ratio on the basis of a light quantity at which the plurality of illumination devices directly illuminate the predetermined spot and a light quantity at which the plurality of illumination devices indirectly illuminate the predetermined spot.

9. The device according to claim 7, wherein the calculation unit is configured to calculate a light quantity ratio at which a sum of power consumption by the plurality of illumination devices is the smallest.

10. The device according to claim 7, wherein the calculation unit is configured to calculate the light quantity ratio so as to preferentially use an illumination device having an accumulation function among the plurality of illumination devices.

11. The device according to claim 7, further comprising:
a second reception unit configured to receive settings of light quantities of the plurality of illumination devices,
wherein the calculation unit configured to calculate a ratio of a light quantity which is equal to or more than the light quantities received by the second reception unit.

12. The device according to claim 7, wherein the calculation unit is further configured to calculate a light quantity ratio at which a sum of rates charged for power consumption of the plurality of illumination devices is the smallest.

13. The device according to claim 7, wherein the plurality of illumination devices include illumination lamps, and
wherein it is determined whether or not, during turning-on of the illumination lamps, illuminance by the illumination lamps can be achieved by any one of the plurality of illumination devices, and, when it is determined that the illuminance can be achieved, the illumination lamps are turned off, and the illumination device is turned on at a rate lower than a rate charged for turning-on of the illumination lamp.

14. An illumination control system comprising:
the illumination control device according to claim 7;
a plurality of illumination lamps; and
a management apparatus configured to manage the plurality of illumination devices.

15. The system according to claim 14, wherein the management apparatus is a home energy management system (HEMS) control apparatus or a building and energy management system (BEMS) control apparatus.
